(19) United States
(12) Patent Application Publication
(10) Pub. No.: US 2024/0267499 A1
(43) Pub. Date: Aug. 8, 2024

(54) PROJECTION DEVICE AND METHOD FOR CONTROLLING THE SAME

(71) Applicant: SAMSUNG ELECTRONICS CO., LTD., Suwon-si (KR)

(72) Inventor: Chulmok LEE, Suwon-si (KR)

(73) Assignee: SAMSUNG ELECTRONICS CO., LTD., Suwon-si (KR)

(21) Appl. No.: 18/396,213

(22) Filed: Dec. 26, 2023

Related U.S. Application Data
(63) Continuation of application No. PCT/KR2023/019688, filed on Dec. 1, 2023.

(30) Foreign Application Priority Data
Feb. 6, 2023 (KR) 10-2023-0015655

(51) Int. Cl. H04N 9/31; G06F 3/04847

(52) U.S. Cl. CPC H04N 9/3188; G06F 3/04847; H04N 9/3147

(57) ABSTRACT

A projector includes: a user interface; an image emitter; a communicator; and at least one processor operatively connected with the user interface, the image emitter, and the communicator, wherein the at least one processor is configured to: generate a first edge blending screen and control the image emitter to output a projection image of the first edge blending screen, based on receiving a request to output a graphic user interface (GUI) while the image emitter outputs the first edge blending screen, update a layout of the first edge blending screen, wherein the updated layout may include a first display area including the GUI and a second display area including a first blending image, and wherein the first display area does not overlap the second display area, and control the image emitter to output a projection image of the first edge blending screen including the updated layout.

### CROSS-REFERENCE TO RELATED APPLICATIONS

This application is a by-pass continuation of International Application No. PCT/KR2023/019688, filed on Dec. 1, 2023, in the Korean Intellectual Property Receiving Office, which is based on and claims priority to Korean Patent Application No. 10-2023-0015655, filed on Feb. 6, 2023, in the Korean Intellectual Property Office, the disclosures of which are hereby incorporated by reference herein in their entireties.

### BACKGROUND

### 1. Field

The disclosure relates to a projection device supporting an edge blending function and a method for controlling the projection device.

### 2. Description of Related Art

Projection devices may be divided into analog projection devices that may provide visual information using a medium, e.g., a film, and digital projection devices that may provide visual information using digital signals. A representative example of the digital projection device is the beam projector (hereinafter, simply referred to as a “projector”). The projector may be classified as a display device. The projector may be implemented as a cathode ray tube (CRT) projector, a liquid crystal display (LCD) projector, or a digital light processing (DLP) projector depending on how to generate light.

The projector is used mainly to display input multimedia content as it is, but as wired/wireless communication networks develop, the projector may be connected to an electronic device, e.g., a digital television (TV), to assist the electronic device.

The projector may be an electronic device that may project slides, photos on a transparent sheet, pictures or text, or images on the screen through a lens. The projector is also called a projection device. The projector may convert file images or video data into an optical image and project or radiate the optical image. The optical image projected or radiated by the projector may be shown on the screen.

The size of the screen displayed by the projector may be limited by the supported resolution, contrast ratio, or brightness. Edge blending may be a method for overcoming such screen size limit.

Edge blending may function to adjust the brightness or color of the blending area which is an overlapping area between the images projected by different projectors to enlarge the screen without resolution, contrast ratio, or brightness loss using at least two projectors.

### SUMMARY

Provided are an image projection device and method for configuring a layout of a screen to be displayed on a screen so that a graphic user interface (GUI) image does not overlap an edge blending image according to an edge blending service.

According to an aspect of the disclosure, a projector includes: a user interface; an image emitter; a communicator; and at least one processor operatively connected with the user interface, the image emitter, and the communicator, wherein the at least one processor is configured to: generate a first edge blending screen and control the image emitter to output a projection image of the first edge blending screen, based on receiving a request to output a graphic user interface (GUI) while the image emitter outputs the first edge blending screen, update a layout of the first edge blending screen, wherein the updated layout may include a first display area including the GUI and a second display area including a first blending image, and wherein the first display area does not overlap the second display area, and control the image emitter to output a projection image of the first edge blending screen including the updated layout.

The at least one processor may be further configured to control the communicator to transmit information about the updated layout to at least one external projector, and the information about the updated layout may include information about a position or a size of a third display area corresponding to a projection image output by the at least one external projector.

The at least one processor may be further configured to: receive, from at least one external projector through the communicator, update request information including a request to update the layout of the first edge blending screen, adjust the second display area based on the update request information, and control the image emitter to output a projection image of the first edge blending screen including the adjusted second display area.

The at least one processor may be further configured to: receive, from at least one external projector through the communicator, update request information including a request to update the layout of the first edge blending screen, adjust the first display area and the second display area based on the update request information, and control the image emitter to output a projection image of the first edge blending screen including the adjusted first display area and the adjusted second display area.

The receiving the request to output the GUI may include receiving, through the user interface, a request to adjust a setting of the projector.

The at least one processor may be further configured to: based on receiving, through the user interface, a request to terminate the output of the GUI, restore the updated layout to the pre-update layout, control the image emitter to output a projection image of the first edge blending screen including the pre-update layout, and control the communicator to transmit to at least one external projection a request to display a second edge blending screen including the pre-update layout.

The at least one processor may be further configured to cause a predetermined area of the second display area to overlap the third display area near at least one edge of the first edge blending screen.

According to an aspect of the disclosure, a method of providing an edge blending screen using a projector, includes: receiving a request to output a graphic user interface (GUI) while an image emitter of the projector outputs a first edge blending screen; updating a layout of the first edge blending screen, wherein the updated layout may include a first display area including the GUI and a second display area including a first blending image, and wherein the first display area does not overlap the second display area; and outputting, by the image emitter, a projection image of the first edge blending screen including the updated layout.

The method may further include transmitting information about the updated layout to at least one external projector.

The method may further include: receiving, from at least one external projector, update request information including a request to update the layout of the first edge blending screen: adjusting the second display area based on the update request information; and outputting a projection image of the first edge blending screen including the adjusted second display area.

The method may further include: receiving, from at least one external projector, update request information including a request to update the layout of the first edge blending screen: adjusting the first display area and the second display area based on the update request information; and outputting a projection image of the first edge blending screen including the adjusted first display area and the adjusted second display area.

The receiving the request to output the GUI may include receiving a request to adjust a setting of the projector.

The method may further include: based on receiving a request to terminate the output of the GUI, restoring the updated layout to the pre-update layout: outputting a projection image of the first edge blending screen including the pre-update layout; and transmitting to at least one external projector a request to display a second edge blending screen including the pre-update layout.

The information about the updated layout may include information about a position or a size of a third display area corresponding to a projection image output by the at least one external projector.

The method may further include causing a predetermined area of the second display area to overlap the third display area near at least one edge by identifying the position or the size of the second display area.

According to an aspect of the disclosure, a system for providing an edge blending screen, includes: a plurality of projectors including a primary projector and a secondary projector, wherein the primary projector may include a first user interface, a first image emitter, a first communicator, and at least one first processor, wherein the secondary projector may include a second user interface, a second image emitter, a second communicator, and at least one second processor, the at least one first processor is configured to generate a first edge blending screen and control the first image emitter to output a projection image of the first edge blending screen, the at least one second processor is configured to generate a second edge blending screen and control the second image emitter to output a projection image of the second edge blending screen, and the at least one first processor may be further configured to cause a predetermined area of the first edge blending screen to overlap the second edge blending screen near at least one edge of the first edge blending screen.

The at least one first processor may be further configured to: based on receiving a request to output a graphic user interface (GUI) while the first image emitter outputs the first edge blending screen, update a layout of the first edge blending screen, wherein the updated layout may include a first display area including the GUI and a second display area including a first blending image, and wherein the first display area does not overlap with the second display area, control the first communicator to transmit information about the updated layout to the secondary projector, and control the first image emitter to output a projection image of the first edge blending screen including the updated layout, and the at least one second processor may be further configured to: based on receiving the information about the updated layout, update a layout of the second edge blending screen, wherein the updated layout of the second edge blending screen may include a third display area including a second blending image and a fourth display area, and wherein the third display area does not overlap with the fourth display area, and adjust the third display area based on the information about the updated layout.

The at least one first processor may be further configured to: receive, from the secondary projector through the first communicator, update request information including a request to update the layout of the first edge blending screen, adjust the second display area based on the update request information, and control the first image emitter to output a projection image of the first edge blending screen including the adjusted second display area.

The at least one first processor may be further configured to: receive, from the secondary projector through the first communicator, update request information including a request to update the layout of the first edge blending screen, adjust the first display area and the second display area based on the update request information, and control the first image emitter to output a projection image of the first edge blending screen including the adjusted first display area and the adjusted second display area.

The at least one first processor is configured to cause a predetermined area of the second display area to overlap the third display area near the at least one edge of the first edge blending screen.

The technical objects of the disclosure are not limited to the foregoing, and other technical objects may be derived by one of ordinary skill in the art from example embodiments of the disclosure.

Effects of the disclosure are not limited to the foregoing, and other unmentioned effects would be apparent to one of ordinary skill in the art from the following description. In other words, unintended effects in practicing embodiments of the disclosure may also be derived by one of ordinary skill in the art from the embodiments of the disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a view illustrating a configuration of a display system supporting an edge blending function according to an embodiment:

FIG. 2A is a view illustrating an example of displaying a default edge blending screen in a display system supporting an edge blending function according to an embodiment:

FIG. 2B is a view illustrating an example of displaying an edge blending screen including a first GUI in a display system supporting an edge blending function according to an embodiment;

FIG. 2C is a view illustrating an example of displaying an edge blending screen including a first GUI and a second GUI in a display system supporting an edge blending function according to an embodiment;

FIG. 2D is a view illustrating an example of displaying an edge blending screen including a second GUI in a display system supporting an edge blending function according to an embodiment;

FIG. 3 is a view illustrating a state of switching operation modes to output a screen in a display system supporting an edge blending function according to an embodiment;

FIG. 4 is a view illustrating a state of switching states to output a screen in a primary device included in a display system supporting an edge blending function according to an embodiment;

FIG. 5 is a flowchart illustrating control for supporting an edge blending service in a display device according to an embodiment;

FIGS. 6A and 6B are flowcharts illustrating control according to a primary operation subroutine in FIG. 5;

FIGS. 7A and 7B are flowcharts illustrating control according to a secondary operation subroutine in FIG. 5; and

FIG. 8 is a block diagram illustrating a configuration of a display device according to an embodiment.

### DETAILED DESCRIPTION

Embodiments of the disclosure are now described with reference to the accompanying drawings in such a detailed manner as to be practiced by one of ordinary skill in the art. However, the disclosure may be implemented in other various forms and is not limited to the embodiments set forth herein. The same or similar reference denotations may be used to refer to the same or similar elements throughout the specification and the drawings. Further, for clarity and brevity, no description is made of well-known functions and configurations in the drawings and relevant descriptions.

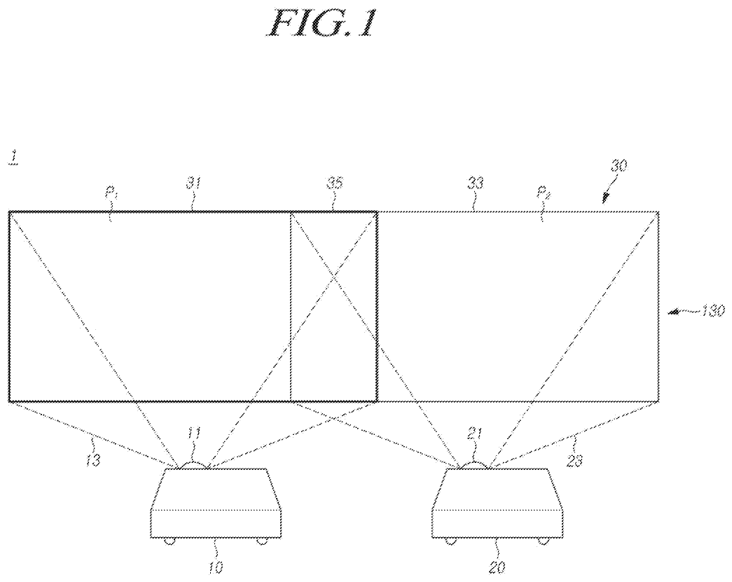

FIG. 1 is a view illustrating a configuration of a display system 1 supporting an edge blending function according to an embodiment.

Referring to FIG. 1, the display system 1 may provide an edge blending screen using an edge blending function. The edge blending function corresponds to a function in which a plurality of projectors (e.g., the first projector 10 and the second projector 20) together project an optical image corresponding to the edge blending image in order to display an image according to a common purpose such as showing a movie on the screen 30. The edge blending image may be, e.g., an image displayed by combining an optical image projected by the first projector 10 (hereinafter, referred to as a “first projection image 13”) and an optical image projected by the second projector 20 (hereinafter, referred to as a “second projection image 23”). The edge blending image may be a full display image made by the first projection image and the second projection image. In the following description, it is assumed that the edge blending image is displayed on the screen 30, but it may be displayed on a plane, such as a wall, rather than the screen 30.

According to an embodiment, the display system 1 may include at least two image projection devices or a screen 30. For example, the display system 1 may include a first image projection device (hereinafter, referred to as a “first projector 10”) and a second image projection device (hereinafter, referred to as a “second projector 20”). The first projector 10 may be a first beam projector. The second projector 20 may be a second beam projector.

The first projector 10 may include a first light output unit 11. The first projector 10 may project the first projection image 13 toward the screen 30 through the first light output unit 11. The projection may mean, e.g., that a beam corresponding to the first projection image 13 is radiated toward the screen 30. The first projection image 13 may allow a first partial display image P₁ to appear in a first partial display area 31 provided on the screen 30.

The second projector 20 may include a second light output unit 21. The second projector 20 may project the second projection image 23 toward the screen 30 through the second light output unit 21. The projection may mean, e.g., that a beam corresponding to the second projection image 23 is radiated toward the screen 30. The second projection image 23 may allow a second partial display image P₂ to appear in a second partial display area 33 provided on the screen 30.

The edge blending image displayed on the screen 30 by the first projection image 13 output by the first projector 10 and the second projection image 23 output by the second projector 20 may include a blended image. The blending image may be an image displayed in a blending area 35 in which the first partial display area 31 and the second partial display area 33 overlap each other in the display area of the screen 30. To that end, the first projector 10 and the second projector 20 may allow an optical image corresponding to a blending image to be displayed in the blending area 35 to have characteristics such as different resolution or contrast from an optical image corresponding to an image to be displayed in another area. This is to prevent the sharpness of the blending image from being lowered because the first projection image 13 and the second projection image 23 are overlaid and displayed.

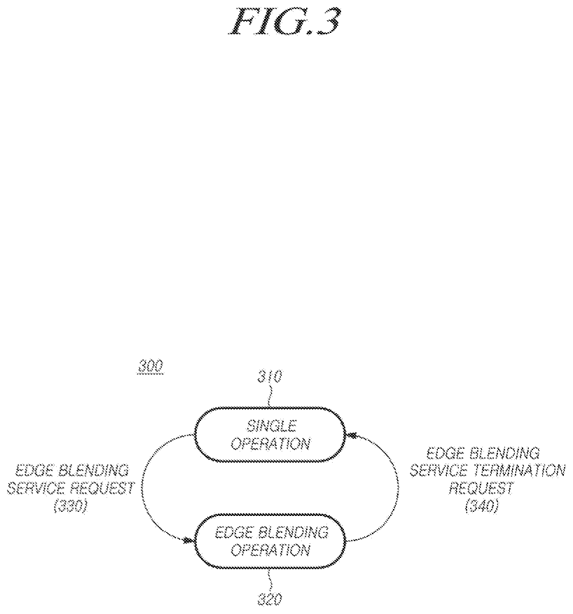

The first projection image 13 output by the first projector 10 may display a target image in a partial area (e.g., the first partial display area 31) or the entire area 130 of the screen 30. For example, in the case of a single operation (e.g., the single operation 310 of FIG. 3), the first projector 10 may output a first projection image 13 for displaying a screen in the entire area 130 of the screen 30 through the first light output unit 11. For example, in the case of an edge blending operation (e.g., the edge blending operation 320 of FIG. 3), the first projector 10 may output the first projection image 13 for displaying a screen in the first partial display area 31 of the screen 30 through the first light output unit 11.

The first projector 10 may establish a communication link with the second projector 20 based on at least one communication scheme of wired or wireless communication with the second projector 20. For example, the first projector 10 may establish a communication link with the second projector 20 using a protocol supporting a direct wireless communication scheme such as Bluetooth or Wi-Fi.

The second projection image 23 output by the second projector 20 may display a target image in a partial area (e.g., the second partial display area 33) or the entire area 130 of the screen 30. For example, in the case of a single operation (e.g., the single operation 310 of FIG. 3), the second projector 20 may output a second projection image 23 for displaying a screen in the entire area 130 of the screen 30 through the second light output unit 21. For example, in the case of an edge blending operation (e.g., the edge blending operation 320 of FIG. 3), the second projector 20 may output the second projection image 23 for displaying a screen in the second partial display area 33 of the screen 30 through the second light output unit 21.

The second projector 20 may establish a communication link with the first projector 10 based on at least one communication scheme of wired or wireless communication with the first projector 10. For example, the second projector 20 may establish a communication link with the first projector 10 using a protocol supporting a direct wireless communication scheme such as Bluetooth or Wi-Fi.

For example, the first projector 10 may function as a primary device or a main device. For example, the second projector 20 may function as a secondary device or a sub device. The first projector 10 may perform main functions as a primary device for displaying the edge blending screen 130 according to the edge blending function on the screen 30. The main functions performed by the primary device may include, e.g., a function of determining an image to be projected by itself (hereinafter, referred to as a “first partial display image”) and an image to be projected by the secondary device (hereinafter, referred to as a “second partial display image”) in order to obtain an edge-blended image.

According to an example, if the edge blending function is activated, the first projector 10 along with the second projector 20 may perform the edge blending operation for displaying the edge blending image on the screen 30. For example, when the first projector 10 operates as a primary device, the first projector 10 may determine a partial display image to be displayed by the first projector 10 and a partial display image to be displayed by the second projector 20 from the edge blending image. For example, when the first projector 10 operates as a primary device, the first projector 10 may transfer information about the first partial display image and/or the second partial display image to the second projector 20. For example, when the first projector 10 operates as a secondary device, the first projector 10 may receive information about the first partial display image and/or the second partial display image from the second projector 20.

The first projector 10 may output a first projection image 13 corresponding to the first partial display image to the screen 30. The first projection image 13 output by the first projector 10 may allow the first partial display image, which is the first blending image, to be displayed in the first partial display area 31 of the screen 30.

The second projector 20 may output a second projection image 23 corresponding to the second partial display image to the screen 30. The second projection image 23 output by the second projector 20 may allow the second partial display image, which is the second blending image, to be displayed in the second partial display area 33 of the screen 30.

According to an embodiment, the first partial display area 31 and the second partial display area 33 may commonly include an overlapping area (e.g., the blending area 35 of FIG. 1). The blending area 35 may be, e.g., an area l₀ in which a position or size defining the second partial display area 33 overlaps the third display area 225 in a predetermined area near at least one edge. In the blending area 35, images commonly included in the first partial display image P₁ and the second partial display image P₂ may be displayed.

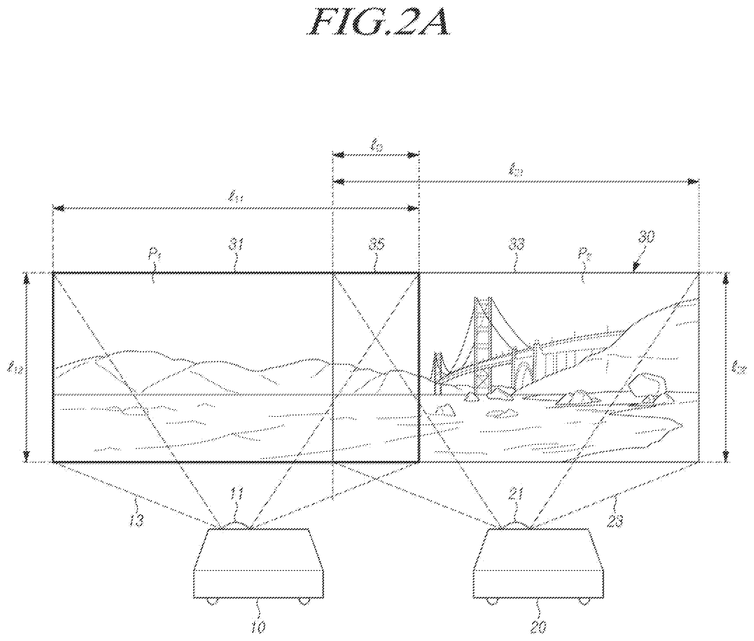

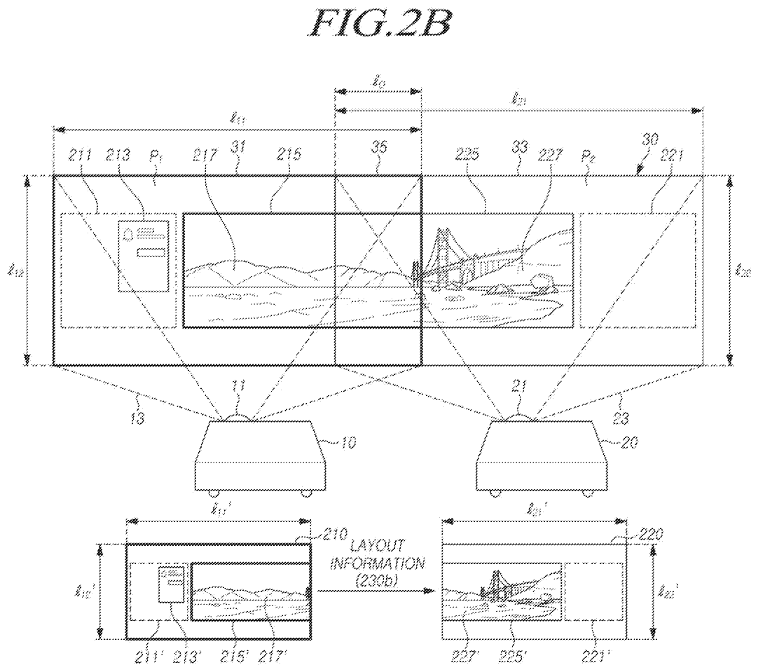

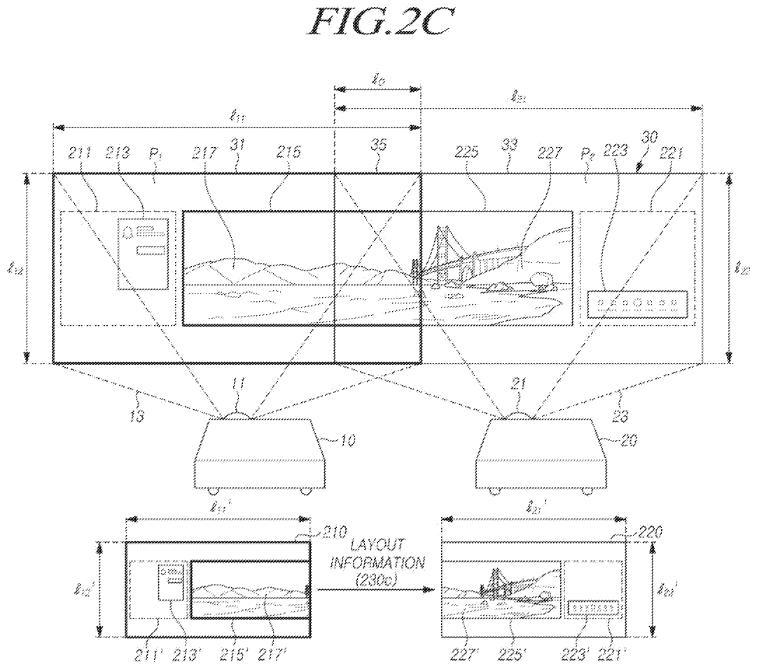

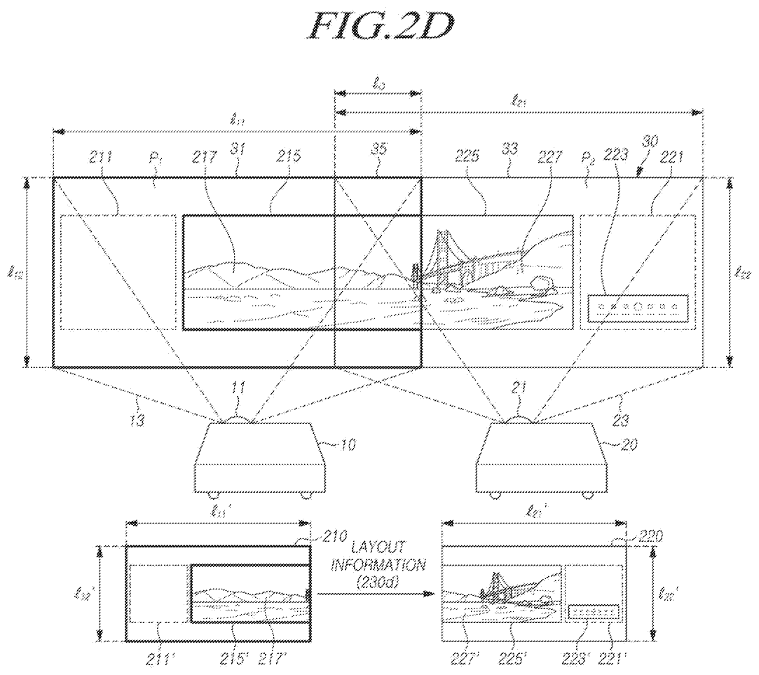

An example of the edge blending screen displayed on the screen 30 by the above-described operations of the first projector 10 and the second projector 20 is illustrated in FIG. 2A. An example in which the first projector 10 or the second projector 20 configures a layout of a virtual screen to output an optical image is also illustrated in FIG. 2A.

According to an embodiment, if a GUI output request is generated after the edge blending function is activated, the first projector 10 may generate a virtual screen to provide a surplus area by reducing an area to display the first partial display image and an area to display the second partial display image together with the second projector 20. The first projector 10 may allocate the provided surplus area as a display area for displaying a GUI image. In this case, the first projector 10 may transfer, to the second projector 20, information about the area in which the first partial display image and/or the second partial display image having the adjusted position or size are to be displayed.

The first projector 10 may generate an image in which the first partial display image is positioned in the adjusted area and the GUI image is disposed in a designated position or size in the surplus area, and may output the image to the screen 30 through the first light output unit 11. The first projection image 13 output by the first projector 10 may allow the GUI image and the first partial display image, which is the first blending image, to be displayed in the first partial display area 31 of the edge blending screen by the changed position and/or size.

The second projector 20 may output the second projection image 23 to the screen 30 so that the second partial display image is displayed in the adjusted area. The second projection image 23 output by the second projector 20 may allow the second partial display image, which is the second blending image, to be displayed in the second partial display area 33 of the edge blending screen by the changed position and/or size.

An example of the edge blending screen displayed on the screen 30 by the above-described operations of the first projector 10 and the second projector 20 is illustrated in FIG. 2B. An example in which the first projector 10 or the second projector 20 configures a layout of a virtual screen to output an optical image is also illustrated in FIG. 2B.

According to an embodiment, if a GUI output request is generated from the second projector 20 after the edge blending function is activated, the first projector 10 may generate a virtual screen to provide a surplus area by reducing an area to display the first partial display image and an area to display the second partial display image together with the second projector 20. The first projector 10 may allocate the provided surplus area as a display area for displaying a GUI image. In this case, the first projector 10 may transfer, to the second projector 20, information about the area in which the second partial display image and/or the GUI image having the adjusted position or size are to be displayed.

The first projector 10 may output the first projection image 13 to the screen 30 so that the first partial display image is displayed in the adjusted area. The first projection image 13 output by the first projector 10 may allow the first partial display image, which is the first blending image, to be displayed in the first partial display area 31 of the screen 30 by the changed position and/or size.

The second projector 20 may output the second projection image 23 to the screen 30 so that the second partial display image is displayed and the GUI image is displayed at a designated position or size in the surplus area. The second projection image 23 output by the second projector 20 may allow the GUI image and the second partial display image, which is the second blending image, to be displayed in the second partial display area 33 of the screen 30 by the changed position and/or size.

An example of the edge blending screen displayed on the screen 30 by the above-described operations of the first projector 10 and the second projector 20 is illustrated in FIG. 2D. An example in which the first projector 10 or the second projector 20 configures a layout of a virtual screen to output an optical image is also illustrated in FIG. 2D.

According to an embodiment, when GUI output requests are sequentially or simultaneously generated from the first projector 10 and the second projector 20 after the edge blending function is activated, the first projector 10 may generate a virtual screen to reduce an area in which the first partial display image and the second partial display image are to be displayed, thereby providing a surplus area. The first projector 10 may allocate a first GUI display area for displaying a first GUI image to a first surplus area provided in the first partial display area 31. The first projector 10 may allocate a second GUI display area for displaying a second GUI image to a second surplus area provided in the second partial display area 33. In this case, the first projector 10 may transfer, to the second projector 20, information about the area in which the second partial display image and/or the second GUI image having the adjusted position or size are to be displayed.

The first projector 10 may output the first projection image 13 to the screen 30 so that the first partial display image is displayed in the adjusted area and the first GUI image is displayed at a designated position or size in the first surplus area. The first projection image 13 output by the first projector 10 may allow the first GUI image and the first partial display image, which is the first blending image, to be displayed in the first partial display area 31 of the screen 30 by the changed position and/or size.

The second projector 20 may output the second projection image 23 to the screen 30 so that the second partial display image is displayed and the second GUI image is displayed at a designated position or size in the surplus area. The second projection image 23 output by the second projector 20 may allow the second GUI image and the second partial display image, which is the second blending image, to be displayed in the second partial display area 33 of the screen 30 by the changed position and/or size.

An example of the edge blending screen displayed on the screen 30 by the above-described operations of the first projector 10 and the second projector 20 is illustrated in FIG. 2C. An example in which the first projector 10 or the second projector 20 configures a layout of a virtual screen to output an optical image is also illustrated in FIG. 2C.

FIG. 2A is a view illustrating an example of displaying a default edge blending screen in a display system (e.g., the display system 1 of FIG. 1) supporting an edge blending function according to an embodiment.

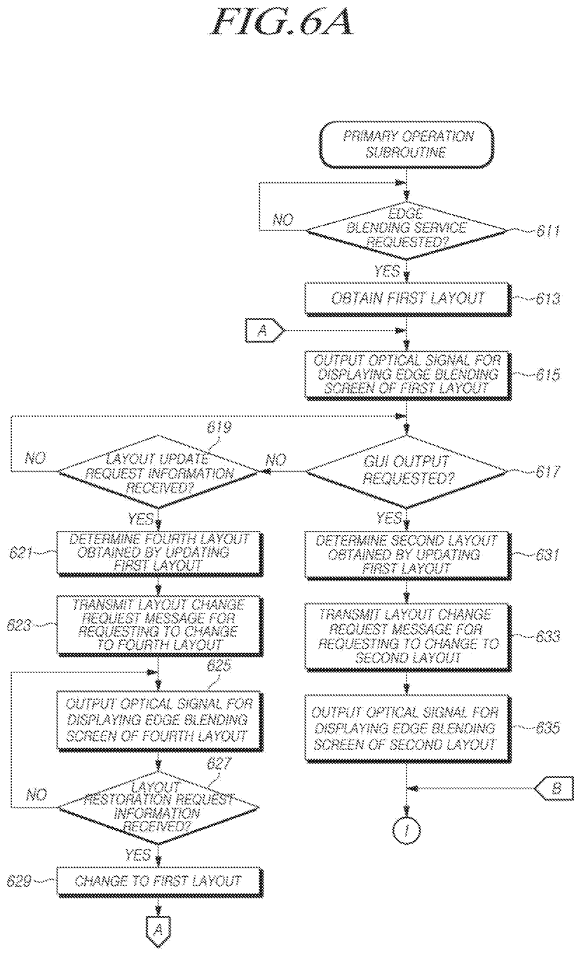

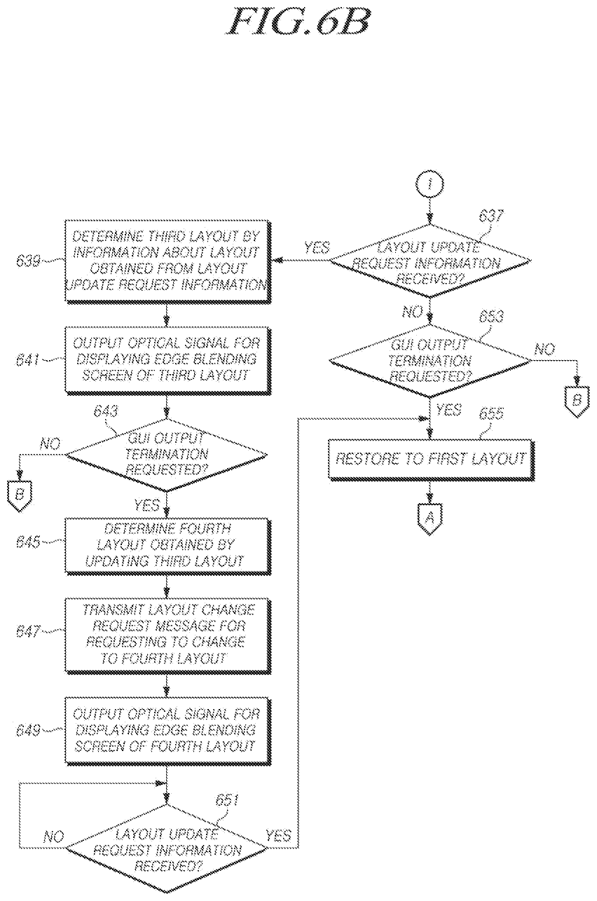

Referring to FIG. 2A, a primary device (e.g., the first projector 10 of FIG. 1) projects an image together with a secondary device (e.g., the second projector 20 of FIG. 1) so that a default edge blending screen is displayed in a display area (e.g., the display area 130 of FIG. 1) of the screen 30. The default edge blending screen may have a structure (e.g., an arrangement structure according to a first layout determined in operation 613 of FIG. 6A) in which a display area allocated to each projector participating in the edge blending service is arranged.

For example, when two projectors (e.g., the first projector 10 and the second projector 20 of FIG. 1) participate in the edge blending service, the first projector 10 may project an optical image (e.g., the first projection image 13 of FIG. 1) onto one area (e.g., the first partial display area 31 of FIG. 1) included in the display area 130. For example, when two projectors (e.g., the first projector 10 and the second projector 20 of FIG. 1) participate in the edge blending service, the second projector 20 may project an optical image (e.g., the second projection image 23 of FIG. 1) onto one area (e.g., the second partial display area 33) included in the display area 130.

A first partial display image P₁ by a projection image (e.g., the first projection image 13 of FIG. 1) output by the first projector 10 may be displayed in the first display area (projection #1) 31 which is one of the two areas. A second partial display image P₂ by a projection image (e.g., the second projection image 23 of FIG. 1) output by the second projector 20 may be displayed in the second partial display area (projection #2) 33 which is the other of the two areas.

According to an embodiment, the first partial display area 31 may have the same size as the second partial display area 33. For example, the horizontal length l₁₁ of the first partial display area 31 may be the same as the horizontal length l₂₁ of the second partial display area 33. The vertical length l₁₂ of the first partial display area 31 may be the same as the vertical length l₂₂ of the second partial display area 33.

According to an embodiment, the first partial display area 31 and the second partial display area 33 may commonly include an overlapping area (e.g., the blending area 35 of FIG. 1). The blending area 35 may be, e.g., an area l₀ in which a position or size defining the second partial display area 33 overlaps the third display area 225 in a predetermined area near at least one edge. In the blending area 35, images commonly included in the first partial display image P₁ and the second partial display image P₂ may be displayed.

FIG. 2B is a view illustrating an example of displaying an edge blending screen including a first GUI in a display system (e.g., the display system 1 of FIG. 1) supporting an edge blending function according to an embodiment.

Referring to FIG. 2B, a primary device (e.g., the first projector 10 of FIG. 1) projects an image together with a secondary device (e.g., the second projector 20 of FIG. 1) so that an edge blending screen including a first GUI is displayed in a display area (e.g., the display area 130 of FIG. 1) of the screen 30. The edge blending screen including the first GUI may have a structure (e.g., an arrangement structure according to a second layout updated in operation 631 of FIG. 6A) in which a display area allocated to each projector participating in the edge blending service is arranged.

For example, when two projectors (e.g., the first projector 10 and the second projector 20 of FIG. 1) participate in the edge blending service, the first projector 10 may project an optical image (e.g., the first projection image 13 of FIG. 1) onto one area (e.g., the first partial display area (projection #1) 31 of FIG. 1) included in the display area 130. For example, when two projectors (e.g., the first projector 10 and the second projector 20 of FIG. 1) participate in the edge blending service, the second projector 20 may project an optical image (e.g., the second projection image 23 of FIG. 1) onto one area (e.g., the second partial display area (projection #2) 33) included in the display area 130.

A first partial display image P₁ by a projection image (e.g., the first projection image 13 of FIG. 1) output by the first projector 10 may be displayed in the first partial display area 31. The first partial display area 31 may include a first GUI display area 211 and a first partial edge blending display area 215. A first GUI image 213 by the first projection image 13 may be displayed in the first GUI display area 211. A first partial edge blending image 217 by the first projection image 13 may be displayed in the first partial edge blending display area 215. In this case, the first partial display image P₁ may include the first GUI image 213 and the first partial edge blending image 217.

A second partial display image P₂ by a projection image (e.g., the second projection image 23 of FIG. 1) output by the second projector 20 may be displayed in the second partial display area 33. The second partial display area 33 may include a second partial edge blending display area 225. A second partial edge blending image 227 by the second projection image 23 may be displayed in the second partial edge blending display area 225. In this case, the second partial display image P₂ may include the second partial edge blending image 227. An area (e.g., the second GUI display area 221 of FIG. 2C) in which a GUI image (e.g., the second GUI image 223 of FIG. 2C) may be displayed by the second projector 20 may be provided in advance in the second partial display area 33.

According to an embodiment, the first projector 10 may determine a layout in which the first virtual GUI display area 211′ and the first virtual partial edge blending display area 215′ are provided on the virtual screen to output the first projection image 13. A first virtual GUI image 213′ may be disposed in the first virtual GUI display area 211′. A first virtual partial edge blending image 217′ may be disposed in the first virtual partial edge blending display area 215′. The layout may be determined considering, e.g., the ratio of the horizontal length l₁₁′ and the vertical length l₁₂′ defining the size of the virtual screen and the horizontal length l₁₁ and the vertical length l₁₂ defining the size of an area (e.g., the first partial display area 31 of FIG. 1) to be displayed on the screen 30.

According to an embodiment, the first projector 10 may transfer layout information 230b to the second projector 20. The layout information 230b may include information that allows the second projector 20 to arrange the second virtual GUI display area 221′ or the second virtual partial edge blending display area 225′ on the virtual screen to output the second projection image 23. A second virtual partial edge blending image 227′ may be disposed in the second virtual partial edge blending display area 225′. The layout may be determined considering, e.g., the ratio of the horizontal length l₂₁′ and the vertical length l₂₂ defining the size of the virtual screen and the horizontal length l₂₁ and the vertical length l₂₂ defining the size of an area (e.g., the first partial display area 31 of FIG. 1) to be displayed on the screen 30.

FIG. 2C is a view illustrating an example of displaying an edge blending screen including a first GUI and a second GUI in a display system (e.g., the display system 1 of FIG. 1) supporting an edge blending function according to an embodiment.

Referring to FIG. 2C, a primary device (e.g., the first projector 10 of FIG. 1) projects an image together with a secondary device (e.g., the second projector 20 of FIG. 1) so that an edge blending screen including a first GUI and a second GUI is displayed in a display area (e.g., the display area 130 of FIG. 1) of the screen 30. The edge blending screen including the first GUI and the second GUI may have a structure (e.g., an arrangement structure according to a third layout obtained in operation 639 of FIG. 6B) in which a display area allocated to each projector participating in the edge blending service is arranged.

For example, when two projectors (e.g., the first projector 10 and the second projector 20 of FIG. 1) participate in the edge blending service, the first projector 10 may project an optical image (e.g., the first projection image 13 of FIG. 1) onto one area (e.g., the first partial display area (projection #1) 31 of FIG. 1) included in the display area 130. For example, when two projectors (e.g., the first projector 10 and the second projector 20 of FIG. 1) participate in the edge blending service, the second projector 20 may project an optical image (e.g., the second projection image 23 of FIG. 1) onto one area (e.g., the second partial display area (projection #2) 33) included in the display area 130.

A first partial display image P₁ by a projection image (e.g., the first projection image 13 of FIG. 1) output by the first projector 10 may be displayed in the first partial display area 31. The first partial display area 31 may include a first GUI display area 211 and a first partial edge blending display area 215. A first GUI image 213 by the first projection image 13 may be displayed in the first GUI display area 211. A first partial edge blending image 217 by the first projection image 13 may be displayed in the first partial edge blending display area 215. In this case, the first partial display image P₁ may include the first GUI image 213 and the first partial edge blending image 217.

A second partial display image P₂ by a projection image (e.g., the second projection image 23 of FIG. 1) output by the second projector 20 may be displayed in the second partial display area 33. The second partial display area 33 may include a second GUI display area 221 and a second partial edge blending display area 225. A second GUI image 223 by the second projection image 23 may be displayed in the second GUI display area 221. A second partial edge blending image 227 by the second projection image 23 may be displayed in the second partial edge blending display area 225. In this case, the second partial display image P₁ may include the second GUI image 223 and the second partial edge blending image 227.

According to an embodiment, the first projector 10 may determine a layout in which the first virtual GUI display area 211′ and the first virtual partial edge blending display area 215′ are provided on the virtual screen to output the first projection image 13. A first virtual GUI image 213′ may be disposed in the first virtual GUI display area 211′. A first virtual partial edge blending image 217′ may be disposed in the first virtual partial edge blending display area 215′. The layout may be determined considering, e.g., the ratio of the horizontal length l₁₁′ and the vertical length l₁₂′ defining the size of the virtual screen and the horizontal length l₁₁ and the vertical length l₁₂ defining the size of an area (e.g., the first partial display area 31 of FIG. 1) to be displayed on the screen 30.

According to an embodiment, the first projector 10 may transfer layout information 230c to the second projector 20. The layout information 230c may include information that allows the second projector 20 to arrange the second virtual GUI display area 221′ and the second virtual partial edge blending display area 225′ on the virtual screen to output the second projection image 23. A second virtual GUI image 223′ may be disposed in the second virtual GUI display area 221′. A second virtual partial edge blending image 227′ may be disposed in the second virtual partial edge blending display area 225′. The layout may be determined considering, e.g., the ratio of the horizontal length l₂₁′ and the vertical length l₂₂′ defining the size of the virtual screen and the horizontal length l₂₁ and the vertical length l₂₂ defining the size of an area (e.g., the first partial display area 31 of FIG. 1) to be displayed on the screen 30.

FIG. 2D is a view illustrating an example of displaying an edge blending screen including a second GUI in a display system (e.g., the display system 1 of FIG. 1) supporting an edge blending function according to an embodiment.

Referring to FIG. 2D, a primary device (e.g., the first projector 10 of FIG. 1) projects an image together with a secondary device (e.g., the second projector 20 of FIG. 1) so that an edge blending screen including a second GUI is displayed in a display area (e.g., the display area 130 of FIG. 1) of the screen 30. The edge blending screen including the second GUI may have a structure (e.g., an arrangement structure according to a fourth layout updated in operation 621 of FIG. 6A) in which a display area allocated to each projector participating in the edge blending service is arranged.

For example, when two projectors (e.g., the first projector 10 and the second projector 20 of FIG. 1) participate in the edge blending service, the first projector 10 may project an optical image (e.g., the first projection image 13 of FIG. 1) onto one area (e.g., the first partial display area (projection #1) 31 of FIG. 1) included in the display area 130. For example, when two projectors (e.g., the first projector 10 and the second projector 20 of FIG. 1) participate in the edge blending service, the second projector 20 may project an optical image (e.g., the second projection image 23 of FIG. 1) onto one area (e.g., the second partial display area (projection #2) 33) included in the display area 130.

A first partial display image P₁ by a projection image (e.g., the first projection image 13 of FIG. 1) output by the first projector 10 may be displayed in the first partial display area 31. The first partial display area 31 may include a first partial edge blending display area 215. A first partial edge blending image 217 by the first projection image 13 may be displayed in the first partial edge blending display area 215. In this case, the first partial display image P₁ may include the first partial edge blending image 217. An area (e.g., the first GUI display area 211 of FIG. 2B) in which a GUI image (e.g., the first GUI image 213 of FIG. 2B) may be displayed by the first projector 10 may be provided in advance in the first partial display area 31.

A second partial display image P₂ by a projection image (e.g., the second projection image 23 of FIG. 1) output by the second projector 20 may be displayed in the second partial display area 33. The second partial display area 33 may include a second GUI display area 221 and a second partial edge blending display area 225. A second GUI image 223 by the second projection image 23 may be displayed in the second GUI display area 221. A second partial edge blending image 227 by the second projection image 23 may be displayed in the second partial edge blending display area 225. In this case, the second partial display image P₁ may include the second GUI image 223 and the second partial edge blending image 227.

According to an embodiment, the first projector 10 may determine a layout in which the first virtual GUI display area 211′ or the first virtual partial edge blending display area 215′ are provided on the virtual screen to output the first projection image 13. A first virtual partial edge blending image 217′ may be disposed in the first virtual partial edge blending display area 215′. The layout may be determined considering, e.g., the ratio of the horizontal length l₁₁′ and the vertical length l₁₂′ defining the size of the virtual screen and the horizontal length l₁₁ and the vertical length l₁₂ defining the size of an area (e.g., the first partial display area 31 of FIG. 1) to be displayed on the screen 30.

According to an embodiment, the first projector 10 may transfer layout information 230d to the second projector 20. The layout information 230d may include information that allows the second projector 20 to arrange the second virtual GUI display area 221′ and the second virtual partial edge blending display area 225′ on the virtual screen to output the second projection image 23. A second virtual GUI image 223′ may be disposed in the second virtual GUI display area 221′. A second virtual partial edge blending image 227″ may be disposed in the second virtual partial edge blending display area 225′. The layout may be determined considering, e.g., the ratio of the horizontal length l₂₁′ and the vertical length l₂₂′ defining the size of the virtual screen and the horizontal length l₂₁ and the vertical length l₂₂ defining the size of an area (e.g., the first partial display area 31 of FIG. 1) to be displayed on the screen 30.

FIG. 3 is a view 300 illustrating switching operation modes to output a screen on the screen (e.g., the screen 30 of FIG. 1) in a display system (e.g., the display system 1 of FIG. 1) supporting an edge blending function according to an embodiment.

Referring to FIG. 3, if an edge blending service is not provided because the edge blending function is not activated, the projector (e.g., the first projector 10 or the second projector 20 of FIG. 1) included in the display system 1 may perform operations according to a single operation 310. The single operation 310 may be, e.g., an operation mode in which each projector (e.g., the first projector 10 or the second projector 20 of FIG. 1) included in the display system 1 operates individually. For example, in the single operation 310, only one of the first projector 10 or the second projector 20 may perform the operation of outputting a projection image to the screen 30. In this case, a screen according to a projection image output by one projector may be displayed on the screen 30.

When an edge blending service request is generated in operation 310 (330), the projector (e.g., the first projector 10 or the second projector 20 of FIG. 1) included in the display system 1 may switch states to perform the edge blending operation 320.

The edge blending operation 320 may be, e.g., an operation mode in which the projectors (e.g., the first projector 10 or the second projector 20 of FIG. 1) included in the display system 1 together display an edge blending screen on the screen 30. For example, in the edge blending operation 320, the first projector 10 and the second projector 20 may cooperate with each other to output a projection image for displaying a target screen. In this case, an edge blending screen according to projection images output by at least two projectors may be displayed on the screen 30.

If an edge blending service termination request is generated in the edge blending operation 320 (340), the projector (e.g., the first projector 10 or the second projector 20 of FIG. 1) included in the display system 1 may switch states to perform the single operation 310.

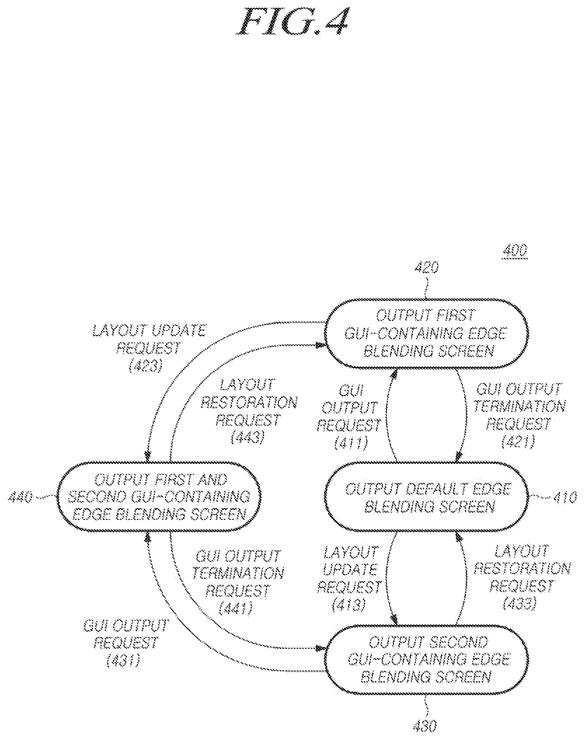

FIG. 4 is a view 400 illustrating switching states to output an edge blending image on a screen (e.g., the screen 30 of FIG. 1) by a projector (e.g., the first projector 10 of FIG. 1) included in a display system (e.g., the display system 1 of FIG. 1) supporting an edge blending function according to an embodiment.

Referring to FIG. 4, if the edge blending function is activated and the state is switched to the edge blending operation (e.g., the edge blending operation 320 of FIG. 3), the first and second projectors 10 and 20 may operate in the default edge blending screen output state 410.

In the default edge blending screen output state 410, the first projector 10 may determine, together with at least one external projector (e.g., the second projector 20 of FIG. 1), a first partial display image (e.g., the first partial display image P₁ of FIG. 2A) to be displayed by itself and a second partial display image (e.g., the second partial display image P₂ of FIG. 2A) to be displayed by its counterpart in the target image. The first partial display image P₁ may include a first partial edge blending image corresponding to a portion of the edge blending image.

The first projector 10 may output a projection image (e.g., the first projection image 13 of FIG. 1) corresponding to the first partial display image P₁ to the screen 30. The first projection image 13 output by the first projector 10 allows the first partial display image P₁, which is the first blending image, to be displayed in the first partial display area 31 of the screen 30.

In the default edge blending screen output state 410, the second projector 20 may output a projection image (e.g., the second projection image 23 of FIG. 1) corresponding to the second partial display image P₂ to the screen 30. The second projection image 23 output by the second projector 20 allows the second partial display image P₂, which is the second blending image, to be displayed in the second partial display area 33 of the screen 30.

The edge blending screen displayed on the screen 30 by the above-described operations of the first projector 10 and the second projector 20 may be as illustrated in FIG. 2A.

According to an embodiment, if a GUI output request is received (411), the first and second projectors 10 and 20 in the default edge blending screen output state 410 may switch to the first GUI-containing edge blending screen output state 420.

In the first GUI-containing edge blending screen output state 420, the first projector 10 may generate a virtual screen and may provide an excess area in the virtual screen. The surplus area may be provided by reducing an area (e.g., the first partial edge blending display area 215 of FIG. 2B) in which a partial edge blending image (e.g., the first partial edge blending image 217 of FIG. 2B) to be included in the first partial display image P₁ is to be displayed. In this case, the first projector 10 may also reduce an area (e.g., the second partial edge blending display area 225 of FIG. 2B) to display a partial edge blending image (e.g., the second partial edge blending image 227 of FIG. 2B) to be included in the second partial display image P₂ considering the reduced first partial edge blending display area 215. The first projector 10 may allocate the surplus area provided by reducing the first partial edge blending display area 215 as a display area (e.g., the first GUI display area 211 of FIG. 2B) for displaying a GUI image (e.g., the first GUI image 213 of FIG. 2B).

The first projector 10 may output the first projection image 13 to the screen 30 considering the updated layout (e.g., the second layout updated in operation 631 of FIG. 6A). The second layout may have a structure in which the first partial edge blending image 217 is displayed in the first partial edge blending display area 215 and the first GUI image 213 is displayed at a designated position or size in the first GUI display area 211. The first projection image 13 output by the first projector 10 may allow the first GUI image 213 and the first partial edge blending image 217, which is the first blending image, to be displayed at the changed position and/or size in the first partial display area 31 of the screen 30.

The second projector 20 in the first GUI-containing edge blending screen output state 420 may output the second projection image 23 to the screen 30 considering the updated layout (e.g., the second layout updated in operation 631 of FIG. 6A). The second layout may have a structure in which the second partial edge blending image 227 is displayed in the second partial edge blending display area 225. The second projection image 23 output by the second projector 20 may allow the second partial edge blending image 227, which is the second blending image, to be displayed at the changed position and/or size in the second partial display area 33 of the screen 30.

An example of the edge blending screen displayed on the screen 30 by the above-described operations of the first projector 10 and the second projector 20 is illustrated in FIG. 2B. An example in which the first projector 10 or the second projector 20 configures a layout of a virtual screen to output an optical image is also illustrated in FIG. 2B.

According to an embodiment, if a GUI output termination request is received (421) in the first GUI-containing edge blending screen output state 420, the first and second projectors 10 and 20 may switch back to the default edge blending screen output state 410. The first and second projectors 10 and 20, which have switched to the default edge blending screen output state 410, may operate so that the first partial display image P₁ and the second partial display image P₂ illustrated in FIG. 2A may be displayed on the screen 30.

According to an embodiment, if a layout update request is received (413), the first and second projectors 10 and 20 in the default edge blending screen output state 410 may switch to the second GUI-containing edge blending screen output state 430.

In the second GUI-containing edge blending screen output state 430, the first projector 10 may generate a virtual screen and may provide an excess area in the virtual screen. The surplus area may be provided by reducing an area (e.g., the second partial edge blending display area 225 of FIG. 2D) in which a partial edge blending image (e.g., the second partial edge blending image 227 of FIG. 2D) to be included in the second partial display image P₂ is to be displayed. In this case, the first projector 10 may also reduce an area (e.g., the first partial edge blending display area 215 of FIG. 2D) to display a partial edge blending image (e.g., the first partial edge blending image 217 of FIG. 2D) to be included in the first partial display image P₁ considering the reduced second partial edge blending display area 225. The first projector 10 may allocate the surplus area provided by reducing the second partial edge blending display area 225 as a display area (e.g., the second GUI display area 221 of FIG. 2D) for displaying a GUI image (e.g., the second GUI image 223 of FIG. 2D). The first projector 10 may allocate the second surplus area as a display area (e.g., the second GUI display area 221 of FIG. 2C) for displaying a GUI image (e.g., the second GUI image 223 of FIG. 2C) by the second projector 20.

The first projector 10 may output the first projection image 13 to the screen 30 considering the updated layout (e.g., the fourth layout obtained in operation 645 of FIG. 6B). The fourth layout may have a structure in which the first partial edge blending image 217 is displayed in the first partial edge blending display area 215. The first projection image 13 output by the first projector 10 may allow the first partial display image P₁ including the first partial edge blending image 217, which is the first blending image, to be displayed at the changed position and/or size in the first partial display area 31 of the screen 30.

The second projector 20 in the second GUI-containing edge blending screen output state 430 may output the second projection image 23 to the screen 30 considering the updated layout (e.g., the fourth layout obtained in operation 645 of FIG. 6B). The fourth layout may have a structure in which the second partial edge blending image 227 is displayed in the second partial edge blending display area 225 and the second GUI image 223 is displayed at a designated position or size in the second GUI display area 221. The second projection image 23 output by the second projector 20 may allow the second GUI image 223 and the second partial edge blending image 227, which is the second blending image, to be displayed at the changed position and/or size in the second partial display area 33 of the screen 30.

An example of the edge blending screen displayed on the screen 30 by the above-described operations of the first projector 10 and the second projector 20 is illustrated in FIG. 2D. An example in which the first projector 10 or the second projector 20 configures a layout of a virtual screen to output an optical image is also illustrated in FIG. 2D.

According to an embodiment, if a layout restoration request is received (433) in the second GUI-containing edge blending screen output state 430, the first and second projectors 10 and 20 may switch back to the default edge blending screen output state 410. The first and second projectors 10 and 20, which have switched to the default edge blending screen output state 410, may operate so that the first partial display image P₁ and the second partial display image P₂ illustrated in FIG. 2A may be displayed on the screen 30.

According to an embodiment, if a layout update request is received (423), the first and second projectors 10 and 20 in the first GUI-containing edge blending screen output state 420 may switch to the first and second GUI-containing edge blending screen output state 440.

In the first and second GUI-containing edge blending screen output state 440, the first projector 10 may generate a virtual screen and may provide an excess area in the virtual screen. The surplus area may include a first surplus area provided by reducing an area (e.g., the second partial edge blending display area 225 of FIG. 2C) for displaying a partial edge blending image (e.g., the first partial edge blending image 217 of FIG. 2C) to be included in the first partial display image P₁, and a second surplus area provided by reducing an area (e.g., the second partial edge blending display area 225 of FIG. 2C) for displaying a partial edge blending image (e.g., the second partial edge blending image 227 of FIG. 2C) to be included in the second partial display image P₂. The first projector 10 may allocate the first surplus area provided in the first partial display area 31 as a display area (e.g., the first GUI display area 211 of FIG. 2C) for displaying a GUI image (e.g., the first GUI image 213 of FIG. 2C) by the first projector 10. The first projector 10 may allocate a second surplus area provided in the second partial display area 33 as a display area (e.g., the second GUI display area 221 of FIG. 2C) for displaying a GUI image (e.g., the second GUI image 223 of FIG. 2C) by the second projector 20.

The first projector 10 may output the first projection image 13 to the screen 30 considering a layout (e.g., the third layout obtained in operation 639 of FIG. 6B) updated to reflect the adjusted first partial display area 31. The third layout may have a structure in which the first partial edge blending image 217 is displayed in the first partial edge blending display area 215 and the first GUI image 213 is displayed at a designated position or size in the first GUI display area 211. The first projection image 13 output by the first projector 10 may allow the first partial display image 210 including the first GUI image and the first partial edge blending image 217, which is the first blending image, to be displayed at the changed position and/or size in the first partial display area 31 of the screen 30.

The second projector 20 in the first and second GUI-containing edge blending screen output state 440 may output the second projection image 23 to the screen 30 considering the layout (e.g., the third layout obtained in operation 639 of FIG. 6B) updated to reflect the adjusted second partial display area 33. The third layout may have a structure in which the second partial edge blending image 227 is displayed in the second partial edge blending display area 225 and the second GUI image 223 is displayed at a designated position or size in the second GUI display area 221. The second projection image 23 output by the second projector 20 may allow the second GUI image 223 and the second partial edge blending image 227, which is the second blending image, to be displayed at the changed position and/or size in the second partial display area 33 of the screen 30.

An example of the edge blending screen displayed on the screen 30 by the above-described operations of the first projector 10 and the second projector 20 is illustrated in FIG. 2C. An example in which the first projector 10 or the second projector 20 configures a layout of a virtual screen to output an optical image is also illustrated in FIG. 2C.

According to an embodiment, if a layout restoration request is received (443), the first and second projectors 10 and 20 in the first and second GUI-containing edge blending screen output state 440 may switch back to the first GUI-containing edge blending screen output state 420. The first and second projectors 10 and 20, which have switched to the first GUI-containing edge blending screen output state 420, may operate so that the first partial display image P₁ and the second partial display image P₂ illustrated in FIG. 2B may be displayed on the screen 30.

According to an embodiment, if a GUI output request is received (431), the first and second projectors 10 and 20 in the second GUI-containing edge blending screen output state 430 may switch to the first and second GUI-containing edge blending screen output state 440. The first and second projectors 10 and 20 having switched to the first and second GUI-containing edge blending screen output state 440 may perform the same operation as when switching from the first GUI-containing edge blending screen output state 420 to the first and second GUI-containing edge blending screen output state 440.

According to an embodiment, if a GUI output termination request is received (441), the first and second projectors 10 and 20 in the first and second GUI-containing edge blending screen output state 440 may switch back to the second GUI-containing edge blending screen output state 430. The first and second projectors 10 and 20, which have switched to the second GUI-containing edge blending screen output state 430, may operate so that the first partial display image P₁ and the second partial display image P₂ illustrated in FIG. 2D may be displayed on the screen 30.

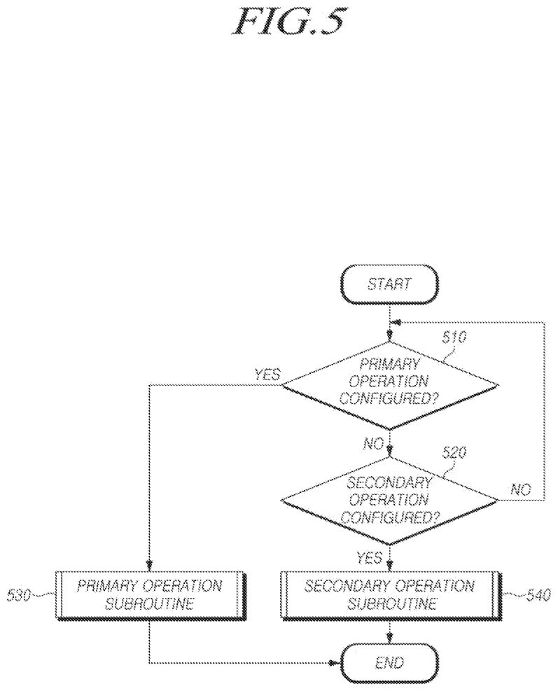

FIG. 5 is a flowchart illustrating control for supporting an edge blending service by a projector (e.g., the first projector 10 of FIG. 1) according to an embodiment. The following description focuses on the first projector 10 for convenience of description, but may likewise apply to other displays (e.g., the second projector 20 of FIG. 1).

Referring to FIG. 5, in operation 510 or 520, the projector 10 may identify an operation (e.g., the edge blending operation 320 of FIG. 3) configured to support the edge blending service. For example, in operation 510, the projector 10 may determine whether a primary operation is configured to be performed in providing the edge blending service. For example, the primary operation may be configured in at least one device (hereinafter, referred to as a “primary device”) among a plurality of devices to together provide the edge blending service. For example, in operation 520, the projector 10 may determine whether a secondary operation is configured to be performed in providing the edge blending service. For example, the secondary operation may be configured in a remaining device (hereinafter, referred to as a “secondary device”) other than at least one primary device among a plurality of devices to together provide the edge blending service.

The projector 10 may determine whether an edge blending service request has occurred before determining whether the projector 10 is configured to operate as a primary device or a secondary device for an edge blending service.

If the projector 10 is configured to operate as a primary device, in operation 530, the projector 10 may perform a primary operation subroutine. The primary operation subroutine defines an operation to be performed by the primary device. For example, the primary device may perform operations according to the control flows of FIGS. 6A and 6B.

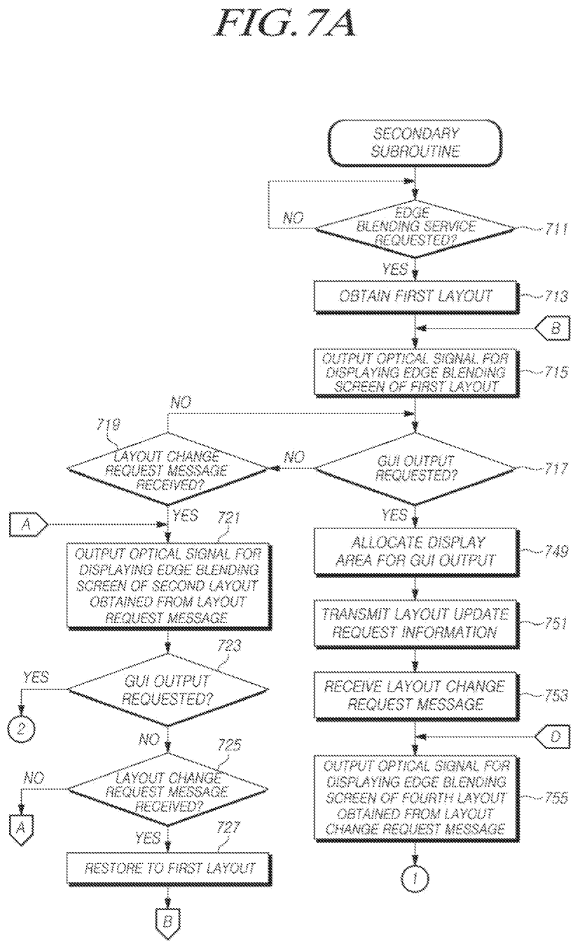

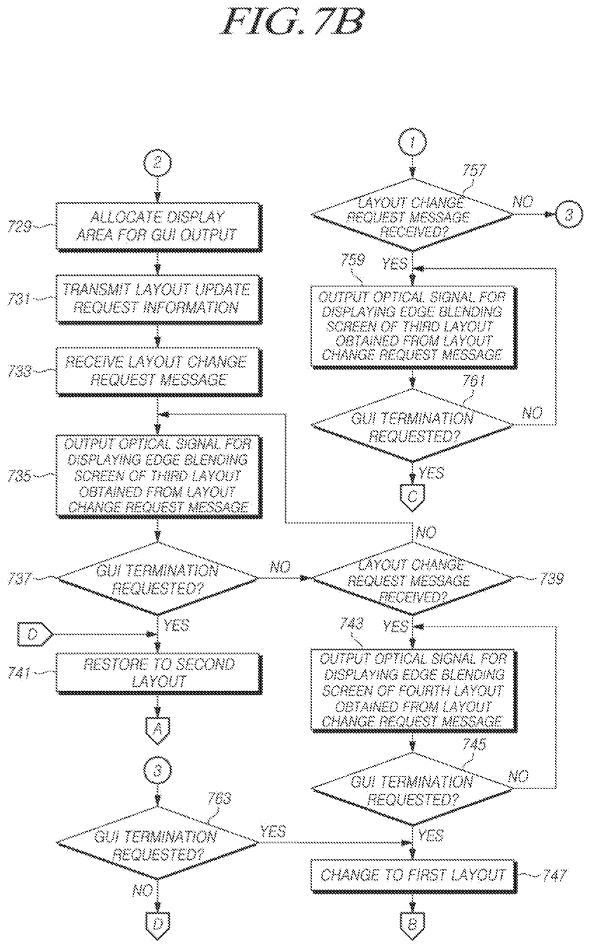

If the projector 10 is configured to operate as a secondary device in the edge blending service, in operation 540, the projector 10 may perform a secondary operation subroutine. The secondary operation subroutine defines an operation to be performed by the secondary device. For example, the secondary device may perform operations according to the control flows of FIGS. 7A and 7B.

According to an embodiment, the primary device may configure or update a layout for an edge blending service. The primary device may configure an initial layout for the edge blending service in response to an edge blending service request. The primary device may configure an initial layout for an edge blending service in response to a termination request for all GUI outputs. The primary device may update the existing layout in response to a GUI output request. The primary device may update the existing layout in response to a GUI output termination request. The primary device may update the existing layout in response to a layout update request from the secondary device. The initial layout or the updated layout may be one of the structures illustrated in FIGS. 2A to 2D. The primary device may output a projection image (e.g., the first projection image 13 of FIG. 1) that is visual information to be displayed on a screen (e.g., the screen 30 of FIG. 1) based on an initial layout configured by the primary device or an updated layout.

According to an embodiment, the secondary device may perform an operation as the secondary device based on the initial layout or updated layout provided from the primary device. The secondary device may transfer a layout update request to the primary device in response to a GUI output request. The secondary device may transfer a layout update request to the primary device in response to a GUI output termination request. The secondary device may receive the layout change request from the primary device in response to the layout update request. The secondary device may receive a layout change request from the primary device even when a GUI output is requested from the primary device or a GUI output termination is requested. The secondary device may update the existing layout in response to the layout change request received from the primary device.

The secondary device may output a projection image (e.g., the second projection image 23 of FIG. 1) that is visual information to be displayed on a screen (e.g., the screen 30 of FIG. 1) based on the initial layout or updated layout received from the primary device.

FIGS. 6A and 6B are flowcharts illustrating control for a projector (e.g., the first projector 10 of FIG. 1) to operate (e.g., operation 530 of FIG. 5) as a primary device according to an embodiment. However, the disclosure is not limited thereto, and in the following description with reference to FIGS. 6A and 6B, the projector 10 may be a secondary device, and the external projector 20 may be a primary device.

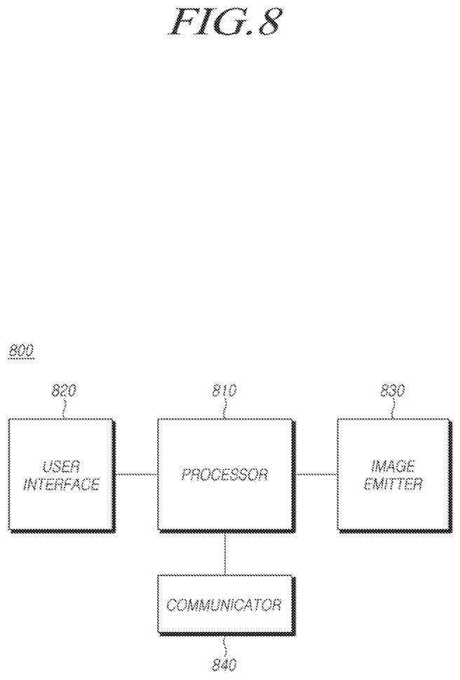

Referring to FIGS. 6A and 6B, in operation 611, the projector 10 may determine whether a request for activating the edge blending function for using the edge blending service is received. The request for activating the edge blending function may be received by, e.g., information input through a user interface (e.g., the user interface 820 of FIG. 8) provided in the projector 10. If the projector 10 receives a request for activating the edge blending function before the primary operation subroutine is started, operation 611 may be omitted.

For example, if a request for activation of the edge blending function is received, the projector 10 may request at least one external projector (e.g., the second projector 20 of FIG. 1) to activate the blending function. The at least one external projector 20 may be an external electronic device to together perform operations for the edge blending service. When the projector 10 is a primary device, the at least one external projector 20 may be a secondary device. At least one external projector 20 to operate as the secondary device may be preconfigured to provide an edge blending service. The projector 10 may transfer information (e.g., layout information) required to provide the edge blending service to the at least one external projector 20. The projector 10 may receive information (e.g., layout information) required to provide the edge blending service from the at least one external projector 20.

For example, the projector 10 may receive a request for activating the edge blending function from the external projector 20. In this case, the projector 10 may receive information (e.g., layout information) required to provide the edge blending service from the at least one external projector 20. The projector 10 may also transfer information (e.g., layout information) required to provide the edge blending service to the at least one external projector 20.

The projector 10 may obtain or determine a first layout in operation 613. The first layout may define an arrangement structure of a display area (e.g., the display area 130 of FIG. 1) of the screen 30. The arrangement structure may allocate a display area to each projector participating in, e.g., an edge blending service.

For example, when the first projector 10 and the second projector 20 participate in the edge blending service, the first layout may define two areas (e.g., the first partial display area (projection #1) 31 and the second partial display area (projection #2) 33 of FIG. 1) in the display area 130 of the screen 30 (see FIG. 2A). A portion of the first partial display area 31 may overlap a portion of the second partial display area 33. One (e.g., the first partial display area 31 of FIG. 1) of the two areas may be allocated for the first projector 10. The remaining one (e.g., the second partial display area 33 of FIG. 1) of the two areas may be allocated for the second projector 20. The first partial display area 31 may have the same size as the second partial display area 33. The horizontal length l₁₁ of the first partial display area 31 may be the same as, e.g., the horizontal length l₂₁ of the second partial display area 33. The vertical length l₁₂ of the first partial display area 31 may be the same as, e.g., the vertical length l₂₂ of the second partial display area 33.

According to an embodiment, the first layout may include first position information or first size information indicating the first partial display area 31. The first position information may be information indicating the position where the first partial display area 31 is disposed in the display area 130 of the screen 30. The first position information may be defined by coordinate values provided to divide the display area 130 of the screen 30 into blocks having a predetermined size. The coordinate value may be, e.g., a coordinate value indicating each of corners of the first partial display area 31. The first size information may include information about the horizontal length l₁₁ or the vertical length l₁₂. The first size information may include an area value of the first partial display area 31.

According to an embodiment, the first layout may include second position information or second size information indicating the second partial display area 33. The second position information may be information indicating the position where the second partial display area 33 is disposed in the display area 130 of the screen 30. The second position information may be defined by coordinate values provided to divide the display area 130 of the screen 30 into blocks having a predetermined size. The coordinate value may be, e.g., a coordinate value indicating each of corners of the second partial display area 33. The second size information may include information about the horizontal length l₂₁ or the vertical length 122. The second size information may include an area value of the second partial display area 33.

According to an embodiment, the first layout may include information defining an overlapping area (e.g., the blending area 35 of FIG. 1) in which the first partial display area 31 and the second partial display area 33 overlap each other. For example, the first layout may include third position information or third size information indicating the blending area 35. The third position information may be information indicating the position where the blending area 35 is disposed in the display area 130 of the screen 30. The third position information may be defined by coordinate values provided to divide the display area 130 of the screen 30 into blocks having a predetermined size. The coordinate value may be, e.g., a coordinate value indicating each of corners of the blending area 35 The third size information may include information about the horizontal length l₀ or the vertical length l₁₂ or l₂₂. The third size information may include an area value of the blending area 35.

For example, the projector 10 may generate a virtual screen in response to a request for activating the edge blending function. The projector 10 may determine a first layout by disposing a first partial display area 31, a second partial display area 33, or a blending area 35 on the generated virtual screen. The first partial display area 31 may include a first partial edge blending display area (e.g., the first partial edge blending display area 215 of FIG. 2B). The second partial display area 33 may include a second partial edge blending display area (e.g., the second partial edge blending display area 225 of FIG. 2B).

In operation 615, the projector 10 may output a projection image (e.g., the first projection image 13 of FIG. 1) toward the screen 30 based on the first layout. The projection image 13 may display the first partial edge blending image 217 in the first partial edge blending display area 215 on the screen 30. The first partial edge blending image 217 may be a portion of an edge blending screen to be displayed on the display area 130 of the screen 30 together with the at least one external projector 20. The projector 10 may generate, e.g., a first projection image 13 obtained by converting an image of a portion allocated to the projector 10 of the entire image to be provided by the edge blending service into light. The entire image may be an edge blending image to be displayed in the display area 130 of the screen 30 together with at least one external projector (e.g., the second projector 20). The projector 10 may configure a first partial edge blending image 217 corresponding to an image portion to be processed by itself of the entire image through prior agreement with the at least one external projector 20.

In operation 617, the projector 10 may monitor whether a GUI output request is received. For example, the projector 10 may recognize that a GUI output request is received in response to receiving a command requesting to execute a setting program. The setting program may be, e.g., a program for adjusting settings for an edge blending function. For example, the command for requesting to execute the setting program may be input through a user interface (e.g., the user interface 820 of FIG. 8) of the projector 10. The command for requesting to execute the setting program may be obtained from, e.g., a control message received through a communicator (e.g., the communicator 840 of FIG. 8) of the projector 10. The control message may be transmitted by an external electronic device (e.g., the second projector 20). The external electronic device may also be, e.g., a portable terminal (e.g., a smartphone or a remote controller) operable by the user.

If the GUI output request is not monitored, the projector 10 may monitor whether a layout update request message is received in operation 619. The layout update request message may include layout update request information. The layout update request information may be transmitted by the external electronic device. The external electronic device may be another projector (e.g., the second projector 20 of FIG. 1) to together perform operations to provide an edge blending service. For example, the layout update request information may include information for changing a layout of an edge blending screen (e.g., FIG. 2A) displayed on the screen 30. The layout update request information may be provided by occurrence of an event requiring a layout change. The event requiring the layout change may occur in the external projector 20. The event requiring the layout change may include, e.g., an event for requesting the external projector 20 to display a GUI.

The layout update request information may include, e.g., information indicating an area (e.g., the first partial edge blending display area 215 of FIG. 2D) in which the projector 10 is to display a blending image (e.g., the first partial edge blending image 217 of FIG. 2D). For example, the information indicating the first partial edge blending display area 215 may include position information or size information indicating the first partial edge blending display area 215. The position information may be information indicating the position where the first partial edge blending display area 215 is disposed in the first partial display area 31 of the screen 30. The position information may be defined by coordinate values provided to divide the first partial display area 31 of the screen 30 into blocks having a predetermined size. The coordinate value may be, e.g., a coordinate value indicating an edge of the first partial edge blending display area 215. The size information may include information about a horizontal length or a vertical length. The size information may include an area value of the first partial edge blending display area 215.

If receiving the layout update request information from the external electronic device (e.g., the second projector 20 of FIG. 1), the projector 10 may determine a fourth layout obtained by updating the first layout in operation 621. The fourth layout may define an arrangement structure for displaying the second GUI image 223 in the second GUI display area 221 in the display area 130 of the screen 30 (see FIG. 2D). For example, when the first projector 10 and the second projector 20 participate in the edge blending service, the fourth layout may define the first partial edge blending display area 215 to be included in the first partial display area 31 of the screen 30. The fourth layout may define the second partial edge blending display area 225 and the second GUI display area 221 to be included in the second partial display area 33 of the screen 30.

According to an embodiment, the fourth layout may include position information or size information indicating the first partial edge blending display area 215. The position information may be information indicating the position where the first partial edge blending display area 215 is disposed in the first partial display area 31 allocated in the screen 30. The first position information may be defined by coordinate values provided to divide the first partial display area 31 of the screen 30 into blocks having a predetermined size. The coordinate value may be, e.g., a coordinate value indicating an edge of the first partial edge blending display area 215. The size information may include information about a horizontal length or a vertical length. The size information may include an area value of the first partial edge blending display area 215.

According to an embodiment, the fourth layout may include position information or size information indicating the second partial edge blending display area 225 and the second GUI display area 221. The position information may be information indicating the position where the second partial edge blending display area 225 or the second GUI display area 221 is disposed in the second partial display area 33 allocated in the screen 30. The position information may be defined by coordinate values provided to divide the first partial display area 31 into blocks having a predetermined size. The coordinate value may be, e.g., a coordinate value indicating an edge of the second partial edge blending display area 225 or the second GUI display area 221. The size information may include information about a horizontal length or a vertical length. The size information may include an area value of the second partial edge blending display area 225 or the second GUI display area 221.

In operation 623, the projector 10 may transmit a layout change request message for requesting a change to the fourth layout to the at least one external projector 20. The layout change request message may include layout change request information. The layout change request information may include the whole or part of the information about the fourth layout. The layout change request information may include, e.g., position information or size information indicating the second partial edge blending display area 225 and the second GUI display area 221 according to the fourth layout.

In operation 625, the projector 10 may output a projection image (e.g., the first projection image 13 of FIG. 4) toward the screen 30 based on the first layout. The projection image 13 may display the first partial edge blending image 217 in the updated first partial edge blending display area 215 on the screen 30. The first partial edge blending image 217 may be a portion of an edge blending screen to be displayed on the display area 130 of the screen 30 together with the at least one external projector 20. The projector 10 may generate, e.g., a first projection image 13 obtained by converting an image of a portion allocated to the projector 10 of the entire image to be provided by the edge blending service into light. The entire image may be an edge blending image to be displayed in the display area 130 of the screen 30 together with at least one external projector (e.g., the second projector 20). The first partial edge blending image 217 to be displayed on the portion allocated thereto may be the same as the image portion considered to output the projection image in operation 615.

In operation 627, the projector 10 may monitor whether layout restoration request information is received from an external electronic device (e.g., the second projector 20 of FIG. 1). For example, the layout restoration request information may be received from another projector (e.g., the second projector 20) to together perform operations to provide an edge blending service. For example, the layout restoration request information may be transferred from another projector when an event in which the layout of the edge blending screen displayed on the screen 30 needs to be restored to the present layout occurs in the other projector. The layout restoration request information may include information about a first layout applied before the update for the projector 10 to display the blending image (e.g., the first partial edge blending image 217 of FIG. 2D). The information about the first layout may be the same as that defined above.

If the layout restoration request information is received, the projector 10 may change the fourth layout corresponding to the information indicating the display area 130 of the screen 30 to the first layout in operation 629. The information about the first layout may be stored, e.g., by the projector 10. After changing to the first layout, the projector 10 may proceed to operation 615 to output the first projection image 13 for displaying the first partial edge blending image 217 to configure the edge blending screen (see FIG. 2A) on the screen 30 based on the first layout, toward the screen 30.

If the GUI output request is monitored, the projector 10 may obtain or determine a second layout in operation 631. The projector 10 may obtain, e.g., the second layout by updating the first layout.

According to an embodiment, the second layout may define a structure of a first partial display area (e.g., the first partial display area 31 of FIG. 2B) in which a first partial display image (e.g., the first partial display image P₁ of FIG. 2B) is to be displayed on the screen 30. The first partial display area 31 may have a structure in which an area (e.g., the first partial edge blending display area 215 of FIG. 2B) in which a blending image (e.g., the first partial edge blending image 217 of FIG. 2B) is to be displayed and an area (e.g., the first GUI display area 211 of FIG. 2B) in which a GUI image (e.g., the first GUI image 213 of FIG. 2B) is to be displayed are disposed.

According to an embodiment, the second layout may define a structure of a second partial display area (e.g., the second partial display area 33 of FIG. 2B) in which a second partial display image (e.g., the second partial display image P₂ of FIG. 2B) is to be displayed on the screen 30. The second partial display area 33 may have a structure in which an area (e.g., the second partial edge blending display area 225 of FIG. 2B) in which a blending image (e.g., the second partial edge blending image 227 of FIG. 2B) is to be displayed is disposed.

For example, when the first projector 10 and the second projector 20 participate in the edge blending service, the second layout may define the first GUI display area 211 and the first partial edge blending display area 215 included in the first partial display area 31 allocated thereto in the display area 130 of the screen 30 (see FIG. 2B). The first GUI display area 211 may have a size different from that of the first partial edge blending display area 215. The second layout may define a second partial edge blending display area 225 included in the second partial display area 33 allocated to the second projector 20 in the display area 130 of the screen 30 (see FIG. 2B).

According to an embodiment, the second layout may include position information or size information indicating the first GUI display area 211. The position information may be information indicating the position where the first GUI display area 211 is disposed in the first partial display area 31 allocated in the screen 30. The first position information may be defined by coordinate values provided to divide the first partial display area 31 of the screen 30 into blocks having a predetermined size. The coordinate value may be, e.g., a coordinate value indicating an edge of the first GUI display area 211. The size information may include information about a horizontal length or a vertical length. The size information may include an area value of the first GUI display area 211.

According to an embodiment, the second layout may include position information or size information indicating the first partial edge blending display area 215. The position information may be information indicating the position where the first partial edge blending display area 215 is disposed in the first partial display area 31 allocated in the screen 30. The position information may be defined by coordinate values provided to divide the first partial display area 31 into blocks having a predetermined size. The coordinate value may be, e.g., a coordinate value indicating an edge of the first partial edge blending display area 215. The size information may include information about a horizontal length or a vertical length. The size information may include an area value of the first partial edge blending display area 215.

According to an embodiment, the second layout may include position information or size information indicating the second partial edge blending display area 225. The position information may be information indicating the position where the second partial edge blending display area 225 is disposed in the second partial display area 33 allocated in the screen 30. The position information may be defined by coordinate values provided to divide the second partial display area 33 into blocks having a predetermined size. The coordinate value may be, e.g., a coordinate value indicating an edge of the second partial edge blending display area 225. The size information may include information about a horizontal length or a vertical length. The size information may include an area value of the second partial edge blending display area 225.

In operation 633, the projector 10 may transmit a layout change request message for requesting a change to the second layout to the at least one external projector (e.g., the second projector 20 of FIG. 1). The layout change request information may include, e.g., an area (e.g., the second partial edge blending display area 225 of FIG. 2B) in which the at least one external projector 20 is to display an edge blending image (e.g., the second partial edge blending image 227 of FIG. 2B) in the second partial display area 33 allocated in the screen 30 in proportion to the first partial edge blending display area 215 whose position or area has been adjusted for the projector 10 to allocate the first GUI display area 211 to display the first GUI image 213. For example, the information indicating the second partial edge blending display area 225 may include position information or size information indicating the second partial edge blending display area 225. The position information may be information indicating the position where the second partial edge blending display area 225 is disposed in the second partial display area 33 of the screen 30. The position information may be defined by coordinate values provided to divide the second partial display area 33 of the screen 30 into blocks having a predetermined size. The coordinate value may be, e.g., a coordinate value indicating an edge of the second partial edge blending display area 225. The size information may include information about a horizontal length or a vertical length. The size information may include an area value of the second partial edge blending display area 225.

In operation 635, the projector 10 may output a projection image (e.g., an optical signal such as the first projection image 13 of FIG. 1) toward the screen 30 so that the first partial display image P₁ is displayed in the first partial display area 31 allocated in the screen 30 based on the second layout. The projection image 13 may display the first GUI image 213 in the first GUI display area 211 and may display the first partial edge blending image 217 in the first partial edge blending display area 215. The projector 10 may generate, e.g., a projection image 13 for displaying, on the screen 30, an edge blending screen (see FIG. 2B) including a first GUI image 213, a first partial edge blending image 217, and a second partial edge blending image 227 together with at least one external projector (e.g., the second projector 20).

In operation 637, the projector 10 may monitor whether layout update request information is received from an external electronic device (e.g., the second projector 20 of FIG. 1). For example, the layout update request information may be received from another projector (e.g., the second projector 20) to together perform operations to provide an edge blending service. For example, the layout update request information may be transferred from another projector 20 when an event for changing the layout of the edge blending screen displayed on the screen 30 occurs in the other projector 20.

According to an embodiment, the layout update request information may include information indicating an area (e.g., the second partial edge blending display area 225 of FIG. 2C) in which the other projector 20 is to display a blending image (e.g., the second partial edge blending image 227 of FIG. 2C). For example, the information indicating the second partial edge blending display area 225 may include position information or size information indicating the second partial edge blending display area 225. The position information may be information indicating the position where the second partial edge blending display area 225 is disposed in the second partial display area 33 of the screen 30. The position information may be defined by coordinate values provided to divide the second partial display area 33 of the screen 30 into blocks having a predetermined size. The coordinate value may be, e.g., a coordinate value indicating an edge of the second partial edge blending display area 225. The size information may include information about a horizontal length or a vertical length. The size information may include an area value of the second partial edge blending display area 225.

According to an embodiment, the layout update request information may include information indicating an area (e.g., the second GUI display area 221 of FIG. 2C) in which the other projector 20 is to display a blending image (e.g., the second GUI image 223 of FIG. 2C). For example, the information indicating the second GUI display area 221 may include position information or size information indicating the second GUI display area 221. The position information may be information indicating the position where the second GUI display area 221 is disposed in the second partial display area 33 of the screen 30. The position information may be defined by coordinate values provided to divide the second partial display area 33 of the screen 30 into blocks having a predetermined size. The coordinate value may be, e.g., a coordinate value indicating an edge of the second GUI display area 221. The size information may include information about a horizontal length or a vertical length. The size information may include an area value of the second GUI display area 221.

In operation 639, the projector 10 may determine a third layout considering layout update request information. The layout update request information may include, e.g., information indicating the second partial edge blending display area 225. The layout update request information may include, e.g., information indicating the second GUI display area 221. The layout update request information may include, e.g., information indicating the second partial edge blending display area 225 and the second GUI display area 221.

In operation 641, the projector 10 may output a projection image (e.g., the first projection image 13 of FIG. 1) for displaying an edge blending screen (see FIG. 2C) on the screen 30 toward the screen 30 based on the third layout.

In operation 643, the projector 10 may monitor whether a GUI output termination request is received. The GUI output termination request may be monitored by, e.g., whether a command for requesting to terminate a setting program being executed to adjust the configuration of the projector 10 is received. For example, the command for requesting to terminate execution of the setting program may be input through a user interface (e.g., the user interface 820 of FIG. 8) included in the projector 10. The command for requesting to terminate execution of the setting program may be monitored through, e.g., a control message transferred from an external electronic device (e.g., the second projector 20 of FIG. 1) through a communicator (e.g., the communicator 840 of FIG. 8) included in the projector 10. The external electronic device may be, e.g., a portable terminal (e.g., a smartphone or a remote controller) operable by the user. If a GUI output termination request is not received from the user, the projector 10 may return to operation 637 and may repeatedly perform subsequent operations.

If the GUI output termination request is received, the projector 10 may determine a fourth layout in operation 645. The fourth layout may define a structure in which an area (e.g., the first partial edge blending display area 215 of FIG. 2B) in which a blending image (e.g., the first partial edge blending image 217 of FIG. 2B) is to be displayed is disposed in an area (e.g., the first partial display area 31 of FIG. 1) in which a blending image is to be displayed on the screen 30. For example, the fourth layout may define an arrangement structure that no longer displays the first GUI image 213 in the first GUI display area 211 (see FIG. 2D). For example, when the first projector 10 and the second projector 20 participate in the edge blending service, the fourth layout may define the first partial edge blending display area 215 included in the first partial display area 31 of the screen 30 and the second partial edge blending display area 225 and the second GUI display area 221 included in the second partial display area 33 of the screen 30.

In operation 647, the projector 10 may transmit a layout change request message for requesting a change to the fourth layout to at least one external projector (e.g., the second projector 20 of FIG. 1) together performing operations for an edge blending service. The layout change request information may include, e.g., information indicating the second GUI display area 221 for displaying the second GUI image 223 and the second partial edge blending display area 225 for displaying the second partial edge blending image 227 in the second partial display area 33 allocated in the screen 30 by the at least one external projector 20. The second GUI display area 221 and the second partial edge blending display area 225 may be updated in proportion to the first partial edge blending display area 215 whose position or area has been adjusted under the assumption that the projector 10 no longer displays the first GUI image 213 in the first GUI display area 211.

For example, the information indicating the second GUI display area 221 may include position information or size information indicating the second GUI display area 221. The position information may be information indicating the position where the second GUI display area 221 is disposed in the second partial display area 33 of the screen 30. The position information may be defined by coordinate values provided to divide the second partial display area 33 of the screen 30 into blocks having a predetermined size. The coordinate value may be, e.g., a coordinate value indicating an edge of the second GUI display area 221. The size information may include information about a horizontal length or a vertical length. The size information may include an area value of the second GUI display area 221.

For example, the information indicating the second partial edge blending display area 225 may include position information or size information indicating the second partial edge blending display area 225. The position information may be information indicating the position where the second partial edge blending display area 225 is disposed in the second partial display area 33 of the screen 30. The position information may be defined by coordinate values provided to divide the second partial display area 33 of the screen 30 into blocks having a predetermined size. The coordinate value may be, e.g., a coordinate value indicating an edge of the second partial edge blending display area 225. The size information may include information about a horizontal length or a vertical length. The size information may include an area value of the second partial edge blending display area 225.

In operation 649, the projector 10 may output a projection image (e.g., an optical signal such as the first projection image 13 of FIG. 1) toward the screen 30 so that the first partial edge blending image 217 is displayed in the first partial edge blending display area 215 allocated in the screen 30 based on the fourth layout. The projector 10 may generate, e.g., a projection image 13 for displaying, on the screen 30, an edge blending screen (see FIG. 2D) including a first partial edge blending image 217, a second partial edge blending image 227, and a second GUI image 223 together with at least one external projector (e.g., the second projector 20).

In operation 651, the projector 10 may monitor whether layout update request information is received from an external electronic device (e.g., the second projector 20 of FIG. 1). For example, the layout update request information may be received from another projector (e.g., the second projector 20) to together perform operations to provide an edge blending service.

For example, the layout update request information may be transferred from another projector 20 when an event for changing the layout of the edge blending screen displayed on the screen 30 occurs in the other projector 20. The layout update request information may include, e.g., information indicating an area (e.g., the second partial edge blending display area 225 of FIG. 2D) in which the projector 10 is to display a blending image (e.g., the second partial edge blending image 227 of FIG. 2D).

For example, the information indicating the second partial edge blending display area 225 may include position information or size information indicating the second partial edge blending display area 225. The position information may be information indicating the position where the second partial edge blending display area 225 is disposed in the second partial display area 33 of the screen 30. The position information may be defined by coordinate values provided to divide the second partial display area 33 of the screen 30 into blocks having a predetermined size. The coordinate value may be, e.g., a coordinate value indicating an edge of the second partial edge blending display area 225. The size information may include information about a horizontal length or a vertical length. The size information may include an area value of the second partial edge blending display area 225.

In operation 653, the projector 10 may monitor whether a GUI output termination request is received from the user while outputting the projection image 13 based on the second layout. The GUI output termination request may be monitored by, e.g., whether a command for requesting to terminate a setting program being executed to adjust the configuration of the projector 10 is received. For example, the command for requesting to terminate execution of the setting program may be input by the user through a user interface (e.g., the user interface 820 of FIG. 8) included in the projector 10. The command for requesting to terminate execution of the setting program may be monitored through, e.g., a control message transferred from an external electronic device (e.g., the second projector 20 of FIG. 1) through a communicator (e.g., the communicator 840 of FIG. 8) included in the projector 10. The external electronic device may be, e.g., a portable terminal (e.g., a smartphone or a remote control) operable by the user. If a GUI output termination request is not received from the user, the projector 10 may return to operation 637 and may repeatedly perform subsequent operations.

If receiving the layout update request information in operation 651 or the GUI output termination request in operation 653, the projector 10 may proceed to operation 655 to restore the layout to the first layout. The information about the first layout may be stored, e.g., by the projector 10. After changing to the first layout, the projector 10 may proceed to operation 615 to output the projection image (e.g., the first projection image 13 of FIG. 1) for displaying the edge blending screen (see FIG. 2A) on the screen 30 based on the first layout toward the screen 30.

If the termination of the edge blending service is requested while performing any one of operations 611 to 655, the projector 10 may terminate the edge blending service being performed and may perform a single operation (e.g., the single operation 310 of FIG. 3).

FIGS. 7A and 7B are flowcharts illustrating control for a projector (e.g., the second projector 20 of FIG. 1) to operate (e.g., operation 540 of FIG. 5) as a secondary device according to an embodiment. However, the disclosure is not limited thereto, and in the following description with reference to FIGS. 7A and 7B, the projector 10 may be a secondary device, and the external projector 20 may be a primary device. Further, in the following description, detailed descriptions of operations that overlap those described above will be omitted.

Referring to FIGS. 7A and 7B, in operation 711, the projector 10 may determine whether a request for activating the edge blending function for using the edge blending service is received. The request for activating the edge blending function may be received by, e.g., information input through a user interface (e.g., the user interface 820 of FIG. 8) provided in the projector 10. If the projector 10 receives a request for activating the edge blending function before the secondary operation subroutine is started, operation 711 may be omitted. The projector 10 may receive a request for activating the edge blending function from the external projector 20 which is the primary device.

The projector 10 may obtain or determine a first layout in operation 713. The first layout may define an arrangement structure of a display area (e.g., the display area 130 of FIG. 1) of the screen 30. The arrangement structure may allocate a display area to each projector participating in, e.g., an edge blending service (see FIG. 2A). The projector 10 may receive information about the first layout from the external projector 20.

In operation 715, the projector 10 may output a projection image (e.g., the second projection image 23 of FIG. 1) toward the screen 30 based on the first layout. The second projection image 23 may display the second partial edge blending image 227 in the second partial edge blending display area 225 on the screen 30.

In operation 717, the projector 10 may monitor whether a GUI output request is received. For example, the projector 10 may recognize that a GUI output request is received in response to receiving a command requesting to execute a setting program. The setting program may be, e.g., a program for adjusting settings for an edge blending function. For example, the command for requesting to execute the setting program may be input through a user interface (e.g., the user interface 820 of FIG. 8) of the projector 10. The command for requesting to execute the setting program may be obtained from, e.g., a control message received through a communicator (e.g., the communicator 840 of FIG. 8) of the projector 10. The control message may be transmitted by the external electronic device (e.g., external projector 20). The external electronic device may also be, e.g., a portable terminal (e.g., a smartphone or a remote controller) operable by the user.

In operation 719, the projector 10 may monitor whether a layout change request message is received. The layout change request message may include layout change request information. The layout change request message may be transmitted by the external electronic device 20. For example, the layout change request information may include information about the second layout.

In operation 721, the projector 10 may obtain a second layout from the layout change request message and may output a projection image (e.g., the second projection image 23 of FIG. 1) toward the screen 30 based on the obtained second layout. The projection image 23 may display the second partial edge blending image 227 in the updated second partial edge blending display area 225 on the screen 30. An image displayed on the screen 30 by outputting the second projection image 23 may be as illustrated in FIG. 2B.

The projector 10 may monitor whether a GUI output request is received in operation 723, and may monitor whether a layout change request message is received in operation 725. If the GUI output request is not received nor is the layout change request message received, the projector 10 may continue to perform operation 721.

If the layout change request message is received, the projector 10 may restore the layout to the first layout in operation 727. The information about the first layout may be stored, e.g., by the projector 10. After changing to the first layout, the projector 10 may proceed to operation 715 to output the projection image (e.g., the second projection image 23 of FIG. 1) for displaying the edge blending screen (see FIG. 2A) on the screen 30 based on the first layout toward the screen 30.

If the GUI output request is received, in operation 729, the projector 10 may allocate a display area (e.g., the second GUI display area 221 of FIG. 2C) to output a GUI image (e.g., the second GUI image 223 of FIG. 2C) to be displayed by itself. The second GUI display area 221 may be allocated by the external projector 20, which is the primary device. In this case, the projector 10 may omit operation 729.

In operation 731, the projector 10 may transmit a layout update request message to the external projector 20. The layout update request message may include layout update request information. For example, the layout update request information may be information to be used for allocating the second GUI display area 221 to display the second GUI image 223 requested to be output or for updating the second partial edge blending display area 225.

The projector 10 may receive a layout change request message in operation 733. The layout change request message may include layout change request information. The layout change request information may include, e.g., position information or size information indicating the second partial edge blending display area 225 and/or the second GUI display area 221 to be included in the second partial display area 33 so that the projector 20 may display the second GUI image 223.

In operation 735, the projector 10 may obtain a third layout obtained by updating the second layout from the layout change request message, and may output a projection image (e.g., the second projection image 23 of FIG. 1) for displaying an edge blending screen (see FIG. 2C) on the screen 30 toward the screen 30 based on the obtained third layout.

In operation 737, the projector 10 may monitor whether a GUI output termination request is received. The GUI output termination request may be monitored by, e.g., whether a command requesting to terminate the function according to the GUI screen being displayed by the projector 10 is received. In operation 739, the projector 10 may monitor whether a layout change request message is received. If the GUI termination request is not received nor is the layout change request message received, the projector 10 may continuously output the second projection image 23 based on the third layout in operation 735.

If the GUI output termination request is received, the projector 10 may perform restoration to the second layout in operation 741. The screen displayed on the screen 30 by the second layout is shown in FIG. 2B. After restoring to the second layout, the projector 10 may perform operation 721.

If the layout change request message is received, in operation 743, the projector 10 may obtain a fourth layout from the layout change request message and may output a projection image (e.g., the second projection image 23 of FIG. 1) toward the screen 30 based on the obtained fourth layout. The projection image 23 may exclude the second GUI image 223 from the second partial display area 33 of the screen 30, and may display only the second partial edge blending image 227. The layout of the virtual screen configured to output the second projection image 23 may be as shown in FIG. 2D. The image displayed on the screen 30 by the second projection image 23 output by the projector 10 based on the layout of the virtual screen may be as illustrated in FIG. 2D.

In operation 745, the projector 10 may monitor whether a GUI output termination request is received. The GUI output termination request may be monitored by, e.g., whether a command requesting to terminate the function according to the GUI screen being displayed by the projector 10 is received.

If the GUI output termination request is not received, the projector 10 may proceed to operation 743 to output the projection image (e.g., the second projection image 23 of FIG. 1) for displaying the edge blending screen (see FIG. 2D) on the screen 30 based on the fourth layout toward the screen 30.

If receiving the GUI output termination request, the projector 10 may restore the layout to the first layout in operation 747. The information about the first layout may be stored, e.g., by the projector 10. After changing to the first layout, the projector 10 may proceed to operation 715 to output the projection image (e.g., the second projection image 23 of FIG. 1) for displaying the edge blending screen (see FIG. 2A) on the screen 30 based on the first layout toward the screen 30.

If the GUI output request is received in a state in which the first layout is applied, in operation 749, the projector 10 may allocate a display area (e.g., the second GUI display area 221 of FIG. 2D) to output a GUI image (e.g., the second GUI image 223 of FIG. 2D) to be displayed by itself. The second GUI display area 221 may be allocated by the external projector 20, which is the primary device. In this case, the projector 10 may omit operation 749.

In operation 751, the projector 10 may transmit a layout update request message to the external projector 20. The layout update request message may include layout update request information. For example, the layout update request information may be information to be used for allocating the second GUI display area 221 to display the second GUI image 223 requested to be output or for updating the second partial edge blending display area 225.

The projector 10 may receive a layout change request message in operation 753. The layout change request message may include layout change request information. The layout change request information may include, e.g., position information or size information indicating the second partial edge blending display area 225 and/or the second GUI display area 221 to be included in the second partial display area 33 so that the projector 20 may display the second GUI image 223.

In operation 755, the projector 10 may obtain a fourth layout obtained by updating the first layout from the layout change request message, and may output a projection image (e.g., the second projection image 23 of FIG. 1) for displaying an edge blending screen (see FIG. 2D) on the screen 30 toward the screen 30 based on the obtained fourth layout.

The projector 10 may monitor whether a layout change request message is received in operation 757, and may monitor whether a GUI output termination request is received in operation 763. The layout change request message may include layout change request information. The layout change request message may be transmitted by the external electronic device (e.g., second projector 20). For example, the layout change request information may include information about the third layout. The GUI output termination request may be monitored by, e.g., whether a command requesting to terminate the function according to the GUI screen being displayed by the projector 10 is received.

If the layout change request message is not received nor is the GUI output termination request received, the projector 10 may proceed to operation 755 to output the projection image (e.g., the second projection image 23 of FIG. 1) for displaying the edge blending screen (see FIG. 2D) on the screen 30 based on the fourth layout toward the screen 30.

If receiving the GUI output termination request, the projector 10 may restore the layout to the first layout in operation 747. The information about the first layout may be stored, e.g., by the projector 10. After changing to the first layout, the projector 10 may proceed to operation 715 to output the projection image (e.g., the second projection image 23 of FIG. 1) for displaying the edge blending screen (see FIG. 2A) on the screen 30 based on the first layout toward the screen 30.

If receiving a layout change request message in a situation where the fourth layout is applied, the projector 10 may obtain a third layout from the layout change request message and may output a projection image (e.g., the second projection image 23 of FIG. 1) for displaying an edge blending screen (see FIG. 2C) on the screen 30 toward the screen 30 based on the obtained third layout in operation 591.

In operation 761, the projector 10 may monitor whether a GUI output termination request is received. The GUI output termination request may be monitored by, e.g., whether a command requesting to terminate the function according to the GUI screen being displayed by the projector 10 is received.

If the GUI termination request is not received, the projector 10 may continuously output the second projection image 23 based on the third layout in operation 759. If the GUI termination request is received, the projector 10 may proceed to operation 741 to perform restoration to the second layout. The screen displayed on the screen 30 by the second layout is shown in FIG. 2B. After restoring to the second layout, the projector 10 may perform operation 721.

If the termination of the edge blending service is requested while performing any one of operations 711 to 763, the projector 10 may terminate the edge blending service being performed and may perform a single operation (e.g., the single operation 310 of FIG. 3).

FIG. 8 is a block diagram illustrating a configuration of a projector 800 (e.g., the first projector 10 of FIG. 1) according to an embodiment.

Referring to FIG. 8, the projector 800 may include at least one processor 810, a user interface 820, an image emitter 830, or a communicator 840.

The user interface 820 may be configured to receive information from the user. For example, the user interface 820 may receive a command or data to be used by a component (e.g., the at least one processor 810) of the projector 800, from the outside (e.g., the user) of the projector 800. The user interface 820 may include, e.g., a microphone, a mouse, a keyboard, a key (e.g., a button), a remote controller, or a digital pen (e.g., a stylus pen).

The user interface 820 may be configured to transmit information to the user. For example, the user interface 820 may output a sound signal to the outside of the projector 10. The user interface 820 may include, e.g., a speaker or a receiver. The speaker may be used for general purposes, such as playing multimedia or playing record. The receiver may be used for receiving incoming calls. The receiver may be implemented as separate from, or as part of the speaker.

The image emitter 830 may be configured to output a projection image (e.g., an optical signal such as the first projection image 13 of FIG. 1) to the screen 30 to output a screen. For example, the image emitter 830 may convert an electrical signal provided from the processor 810 into a projection image 13 and output the projection image 13 toward a screen (e.g., the screen 30 of FIG. 1). The electrical signal provided by the processor 810 may correspond to image data such as a photo or a video.

The communicator 840 may be configured to exchange information with at least one electronic device. The communicator 840 may transmit and receive data or signals to and from an external device or a server. The communicator 840 may include, but is not limited to, a Bluetooth communication unit, a Bluetooth low energy (BLE) communication unit, a near field communication unit, a WLAN (Wi-Fi) communication unit, a Zigbee communication unit, an infrared data association (IrDA) communication unit, a Wi-Fi direct (WFD) communication unit, an ultrawideband (UWB) communication unit, an Ant+ communication unit, or a microwave (uWave) communication unit.

According to an embodiment, the communicator 840 may support establishing a direct (e.g., wired) communication channel or a wireless communication channel with an external projector (e.g., the second projector 20 of FIG. 1) and performing communication through the established communication channel. The communicator 840 may include one or more communication processors supporting direct (e.g., wired) communication or wireless communication. The one or more communication processors may be operated independently of the processor 810. The communicator 840 may include, e.g., a wireless communication module (e.g., a cellular communication module, a short-range wireless communication module, or a global navigation satellite system (GNSS) communication module) or a wired communication module (e.g., a local area network (LAN) communication module or a power line communication module). A corresponding one of these communication modules may communicate with at least one other projector (e.g., the second projector 20), which is an external electronic device, via a network (e.g., a short-range communication network, such as Bluetooth™, wireless-fidelity (Wi-Fi) direct, or infrared data association (IrDA)) or a long-range communication network, such as a legacy cellular network, a 5G network, a next-generation communication network, the Internet, or a computer network (e.g., local area network (LAN) or wide area network (WAN)). These various types of communication modules may be implemented as a single component (e.g., a single chip), or may be implemented as multi components (e.g., multiple chips) separate from each other.

The processor 810 may execute software to control at least one other component (e.g., a hardware or software component) such as the user interface 820, the image emitter 830, or the communicator 840, which is electrically connected thereto, or may process or compute various data. As at least portion of data processing or computation, the processor 810 may store a command or data received from another component (e.g., the user interface 820 or the communicator 840) in a storage unit (e.g., a volatile memory) or process the command or data stored in the storage unit and store the processed resultant data in the storage unit.

According to an embodiment, if the edge blending function is activated, the processor 810 may determine a first partial display image to be displayed by the processor 810 and a second partial display image to be displayed by the counterpart from the target image. For example, the processor 810 may control the communicator 840 to transfer information about the first partial display image and/or the second partial display image to the second projector 20. For example, the processor 810 may receive information about the first partial display image and/or the second partial display image from the second projector 20 through the communicator 840.

The processor 810 may control the image emitter 830 to output a first projection image (e.g., the first projection image 13 of FIG. 1) corresponding to the first partial display image to the screen 30. The first projection image 13 output by the image emitter 830 under the control of the processor 810 may allow the first partial display image, which is the first blending image, to be displayed in the first partial display area 31 of the screen 30.

According to the above-described operation, the edge blending screen illustrated in FIG. 2A may be displayed on the virtual screen or the screen 30.

According to an embodiment, if a GUI output request is generated after the edge blending function is activated, the processor 810 may generate a virtual screen to provide a surplus area by reducing an area to display the first partial display image and an area to display the second partial display image. The processor 810 may allocate the provided surplus area as a display area for displaying a GUI image. In this case, the processor 810 may control the communicator 840 to transfer, to the second projector 20, information about the area in which the first partial display image and/or the second partial display image having the adjusted position or size are to be displayed.

The processor 810 may control the image emitter 830 to output the first projection image 13 to the screen 30 so that the first partial display image is displayed in the adjusted area and the GUI image is displayed at a designated position or size in the surplus area. The first projection image 13 output from the image emitter 830 under the control of the processor 810 may allow the GUI image and the first partial display image, which is the first blending image, to be displayed in the first partial display area 31 of the screen 30 by the changed position and/or size.

According to the above-described operation, the edge blending screen illustrated in FIG. 2B may be displayed on the screen 30.

According to an embodiment, if a GUI output request is generated from the second projector 20 after the edge blending function is activated, the processor 810 may generate a virtual screen to provide a surplus area by reducing an area to display the first partial display image and an area to display the second partial display image. The processor 810 may allocate the provided surplus area as a display area for displaying a GUI image. In this case, the processor 810 may control the communicator 840 to transfer, to the second projector 20, information about the area in which the second partial display image and/or the GUI image having the adjusted position or size are to be displayed.

The processor 810 may control the image emitter 830 to output the first projection image 13 to the screen 30 so that the first partial display image is displayed in the adjusted area. The first projection image 13 output from the image emitter 830 under the control of the processor 810 may allow the first partial display image, which is the first blending image, to be displayed in the first partial display area 31 of the screen 30 by the changed position and/or size.

According to the above-described operation, the processor 810 may control the image emitter 830 to project the optical image based on the layout of the virtual screen shown in FIG. 2D. The projected optical image may display the edge blending screen shown in FIG. 2D on the screen 30.

According to an embodiment, when GUI output requests are sequentially or simultaneously generated from the first projector 10 and the second projector 20 after the edge blending function is activated, the processor 810 may generate a virtual screen to reduce an area in which the first partial display image and the second partial display image are to be displayed, thereby providing a surplus area. The processor 810 may allocate a first GUI display area for displaying a first GUI image to a first surplus area provided in the first partial display area 31. The processor 810 may allocate a second GUI display area for displaying a second GUI image to a second surplus area provided in the second partial display area 33. In this case, the processor 810 may control the communicator 840 to transfer, to the second projector 20, information about the area in which the second partial display image and/or the second GUI image having the adjusted position or size are to be displayed.

The processor 810 may control the image emitter 830 to output the first projection image 13 to the screen 30 so that the first partial display image is displayed in the adjusted area and the first GUI image is displayed at a designated position or size in the first surplus area. The first projection image 13 output from the image emitter 830 under the control of the processor 810 may allow the first GUI image and the first partial display image, which is the first blending image, to be displayed in the first partial display area 31 of the screen 30 by the changed position and/or size.

According to the above-described operation, the processor 810 may control the image emitter 830 to project the optical image based on the layout of the virtual screen shown in FIG. 2C. The projected optical image may display the edge blending screen shown in FIG. 2C on the screen 30.

The electronic device according to various embodiments of the disclosure may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used herein, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program) including one or more instructions that are stored in a storage medium (e.g., memory) that is readable by a machine (e.g., the display system 1). For example, a processor (e.g., the processor 810) of the machine (e.g., the first projector 10) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The storage medium readable by the machine may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program products may be traded as commodities between sellers and buyers. The computer program product may be distributed in the form of a machine-readable storage medium (e.g., compact disc read only memory (CD-ROM)), or be distributed (e.g., downloaded or uploaded) online via an application store (e.g., Play Store™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities. Some of the plurality of entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

What is claimed is:

1. A projector comprising:
a user interface;
an image emitter;
a communicator; and
at least one processor operatively connected with the user interface, the image emitter, and the communicator,
wherein the at least one processor is configured to:
generate a first edge blending screen and control the image emitter to output a projection image of the first edge blending screen,
based on receiving a request to output a graphic user interface (GUI) while the image emitter outputs the first edge blending screen, update a layout of the first edge blending screen, wherein the updated layout comprises a first display area comprising the GUI and a second display area comprising a first blending image, and wherein the first display area does not overlap the second display area, and
control the image emitter to output a projection image of the first edge blending screen including the updated layout.

2. The projector of claim 1, wherein the at least one processor is further configured to control the communicator to transmit information about the updated layout to at least one external projector, and
wherein the information about the updated layout comprises information about a position or a size of a third display area corresponding to a projection image output by the at least one external projector.

3. The projector of claim 1, wherein the at least one processor is further configured to:
receive, from at least one external projector through the communicator, update request information comprising a request to update the layout of the first edge blending screen,
adjust the second display area based on the update request information, and
control the image emitter to output a projection image of the first edge blending screen including the adjusted second display area.

4. The projector of claim 1, wherein the at least one processor is further configured to:
receive, from at least one external projector through the communicator, update request information comprising a request to update the layout of the first edge blending screen,
adjust the first display area and the second display area based on the update request information, and
control the image emitter to output a projection image of the first edge blending screen including the adjusted first display area and the adjusted second display area.

5. The projector of claim 1, wherein the receiving the request to output the GUI comprises receiving, through the user interface, a request to adjust a setting of the projector.

6. The projector of claim 1, wherein the at least one processor is further configured to:
based on receiving, through the user interface, a request to terminate the output of the GUI, restore the updated layout to the pre-update layout,
control the image emitter to output a projection image of the first edge blending screen including the pre-update layout, and
control the communicator to transmit to at least one external projection a request to display a second edge blending screen including the pre-update layout.

7. The projector of claim 2, wherein the at least one processor is further configured to cause a predetermined area of the second display area to overlap the third display area near at least one edge of the first edge blending screen.

8. A method of providing an edge blending screen using a projector, the method comprising:
receiving a request to output a graphic user interface (GUI) while an image emitter of the projector outputs a first edge blending screen;
updating a layout of the first edge blending screen, wherein the updated layout comprises a first display area comprising the GUI and a second display area comprising a first blending image, and wherein the first display area does not overlap the second display area; and
outputting, by the image emitter, a projection image of the first edge blending screen including the updated layout.

9. The method of claim 8, further comprising transmitting information about the updated layout to at least one external projector.

10. The method of claim 8, further comprising:
receiving, from at least one external projector, update request information comprising a request to update the layout of the first edge blending screen;
adjusting the second display area based on the update request information; and
outputting a projection image of the first edge blending screen including the adjusted second display area.

11. The method of claim 8, further comprising:
receiving, from at least one external projector, update request information comprising a request to update the layout of the first edge blending screen;
adjusting the first display area and the second display area based on the update request information; and
outputting a projection image of the first edge blending screen including the adjusted first display area and the adjusted second display area.

12. The method of claim 8, wherein the receiving the request to output the GUI comprises:
receiving a request to adjust a setting of the projector.

13. The method of claim 8, further comprising:
based on receiving a request to terminate the output of the GUI, restoring the updated layout to the pre-update layout;
outputting a projection image of the first edge blending screen including the pre-update layout; and
transmitting to at least one external projector a request to display a second edge blending screen including the pre-update layout.

14. The method of claim 9, wherein the information about the updated layout comprises information about a position or a size of a third display area corresponding to a projection image output by the at least one external projector.

15. The method of claim 14, further comprising causing a predetermined area of the second display area to overlap the third display area near at least one edge by identifying the position or the size of the second display area.

16. A system for providing an edge blending screen, the system comprising:
a plurality of projectors comprising a primary projector and a secondary projector, wherein the primary projector comprises a first user interface, a first image emitter, a first communicator, and at least one first processor,
wherein the secondary projector comprises a second user interface, a second image emitter, a second communicator, and at least one second processor,
wherein the at least one first processor is configured to generate a first edge blending screen and control the first image emitter to output a projection image of the first edge blending screen,
wherein the at least one second processor is configured to generate a second edge blending screen and control the second image emitter to output a projection image of the second edge blending screen, and
wherein the at least one first processor is further configured to cause a predetermined area of the first edge blending screen to overlap the second edge blending screen near at least one edge of the first edge blending screen.

17. The system of claim 16, wherein the at least one first processor is further configured to:
based on receiving a request to output a graphic user interface (GUI) while the first image emitter outputs the first edge blending screen, update a layout of the first edge blending screen, wherein the updated layout comprises a first display area comprising the GUI and a second display area comprising a first blending image, and wherein the first display area does not overlap with the second display area,
control the first communicator to transmit information about the updated layout to the secondary projector, and
control the first image emitter to output a projection image of the first edge blending screen including the updated layout, and
wherein the at least one second processor is further configured to:
based on receiving the information about the updated layout, update a layout of the second edge blending screen, wherein the updated layout of the second edge blending screen comprises a third display area comprising a second blending image and a fourth display area, and wherein the third display area does not overlap with the fourth display area, and
adjust the third display area based on the information about the updated layout.

18. The system of claim 17, wherein the at least one first processor is further configured to:
receive, from the secondary projector through the first communicator, update request information comprising a request to update the layout of the first edge blending screen,
adjust the second display area based on the update request information, and
control the first image emitter to output a projection image of the first edge blending screen including the adjusted second display area.

19. The system of claim 17, wherein the at least one first processor is further configured to:
receive, from the secondary projector through the first communicator, update request information comprising a request to update the layout of the first edge blending screen,
adjust the first display area and the second display area based on the update request information, and
control the first image emitter to output a projection image of the first edge blending screen including the adjusted first display area and the adjusted second display area.

20. The system of claim 17, wherein the at least one first processor is configured to cause a predetermined area of the second display area to overlap the third display area near the at least one edge of the first edge blending screen.
